(19) United States
(12) Patent Application Publication
(10) Pub. No.: US 2023/0017934 A1
(43) Pub. Date: Jan. 19, 2023

(54) IMAGE ENCODING AND DECODING METHODS AND APPARATUSES

(71) Applicant: HUAWEI TECHNOLOGIES CO., LTD., Shenzhen (CN)

(72) Inventors: Jiahui LI, Shenzhen (CN); Mengyao MA, Shenzhen (CN); Min YAN, Shenzhen (CN); Wei LIN, Shenzhen (CN)

(73) Assignee: HUAWEI TECHNOLOGIES CO., LTD., Shenzhen (CN)

(21) Appl. No.: 17/941,552

(22) Filed: Sep. 9, 2022

Related U.S. Application Data
(63) Continuation of application No. PCT/CN2021/080541, filed on Mar. 12, 2021.

(30) Foreign Application Priority Data
Mar. 13, 2020 (CN) 202010177478.7

(51) Int. Cl. H04N 19/34; H04N 19/124

(52) U.S. Cl. CPC H04N 19/34; H04N 19/124

(57) ABSTRACT

This application discloses image encoding and decoding methods and apparatuses. The image encoding method includes performing, by a source device, compression encoding on an image to obtain base layer information. The method further includes obtaining enhancement layer information based on the base layer information and the image. The method further includes obtaining control layer information. The method further includes performing encoding and modulation on the control layer information, the base layer information, and the enhancement layer information separately to obtain a plurality of symbol sets. The method further includes mapping the plurality of symbol sets to a resource for sending. Embodiments of this application may ensure robustness in a transmission process and improve overall compression efficiency and performance.

### CROSS-REFERENCE TO RELATED APPLICATIONS

This application is a continuation of International Application No. PCT/CN2021/080541, filed on Mar. 12, 2021, which claims priority to Chinese Patent Application No. 202010177478.7, filed on Mar. 13, 2020. The disclosures of the aforementioned applications are hereby incorporated by reference in their entireties.

### TECHNICAL FIELD

Embodiments of this application generally relate to multimedia communication technologies, and in particular, to image encoding and decoding methods and apparatuses.

### BACKGROUND

With the development of the field of information technology, there has been higher requirements for integrated services. Some examples of these integrated services include the enjoyment of voice services, receiving and sending data, receiving and sending images, and receiving and sending videos at anytime and anywhere and through different multimedia services. Therefore, multimedia communication has become a focus of people's attention. Videos are an important part of multimedia data, as videos need to be precise, in real-time, visual, in a high resolution, concrete, and vivid. Accordingly, the audio-visual experience is important to users. In the next few years, a wireless video service will have a broader development prospect, and a wireless video coding and transmission technology will become a research hotspot in the current multimedia communication field. Due to a limited bandwidth of a radio channel, video data needs to be efficiently compressed. However, when the video data is efficiently compressed by using a video coding technology, such as through predictive coding and variable length coding, a bit stream has a very high requirement for a bit error rate of a channel. Due to various types of noise interference in radio channels, it is a quite challenging task to transmit high-quality video over radio channel. Coding is one of the critical issues for transmitting high-quality video over radio channels. Coding is substantially classified (e.g., categorized) into source coding and channel coding. A main indicator of the source coding is its coding efficiency. A main objective of the channel coding is to improve reliability of information transmission.

In a related technology, a digital video communication system based on joint source and channel coding can implement soft transmission during adaptive channel coding, but is low in compression efficiency during source coding, resulting in low overall transmission efficiency.

### SUMMARY

Embodiments of this application provide for image encoding and decoding methods and apparatuses, to ensure robustness in a transmission process and improve overall compression efficiency and performance.

According to a first aspect, an embodiment of this application provides an image encoding method. The method includes: performing compression encoding on an image to obtain base layer information; obtaining enhancement layer information based on the base layer information and the image; obtaining control layer information, where the control layer information includes higher-layer control information, and control information of the base layer information and the enhancement layer information; separately performing channel encoding and modulation on the control layer information, the base layer information, and the enhancement layer information to obtain a plurality of symbol sets; and mapping the plurality of symbol sets to a resource for transmission (e.g., sending).

In this disclosure, the base layer information that is obtained after a source is encoded, residual information that is between the original source and the base layer information and that is used as the enhancement layer information, and the control layer information that is generated in a processing process and that is from a higher layer are combined. Independent and different encoding/decoding algorithms and modulation/demodulation schemes are used. The base layer information includes contour or rough information of the image. A user can learn the general meaning conveyed by the original image from an image restored based on the information. In addition, the base layer information has a small data amount and has a bit rate hundreds or even thousands of times less than that of the original source. Therefore, a lower-rate encoding/decoding algorithm and a lower-order modulation/demodulation scheme may be used for completing subsequent processing, to ensure robustness in a transmission process. The enhancement layer information cannot independently restore a recognizable image, but may be used for enhancing a visual effect of a base layer based on the base layer information. Based on the importance of an enhancement sublayer information of the enhancement layer information, and compared with those for the base layer information, a higher-rate encoding/decoding algorithm and a higher-order modulation/demodulation scheme may be used for completing the subsequent processing. The control layer information includes the higher-layer control information, and the control information used in a processing process of the base layer information and the enhancement layer information. Based on importance of the control layer information, the lower-rate encoding/decoding algorithm and the lower-order modulation/demodulation scheme may alternatively be used for completing the subsequent processing, to ensure robustness in the transmission process. In this layered processing manner, a to-be-compressed information bit stream with a higher sparsity can be obtained, and may help improve overall compression efficiency and performance.

In embodiments, the obtaining enhancement layer information based on the base layer information and the image includes: decoding the base layer information to obtain a restored image; calculating a residual of the image and the restored image to obtain residual information; and performing partition, transform, and quantization processing on the residual information to obtain the enhancement layer information.

In embodiments, the performing channel encoding and modulation are done separately on the control layer information, the base layer information, and the enhancement layer information to obtain a plurality of symbol sets and includes: performing, on the control layer information, channel encoding by using a first encoding algorithm and performing modulation by using a first modulation scheme to obtain a first symbol set; performing, on the base layer information, channel encoding by using a second encoding algorithm and performing modulation by using a second modulation scheme to obtain a second symbol set; and performing, on the enhancement layer information, channel encoding by using at least one encoding algorithm and performing modulation by using at least one modulation scheme to obtain a third symbol set. The at least one encoding algorithm does not include the first encoding algorithm or the second encoding algorithm, and the at least one modulation scheme does not include the first modulation scheme or the second modulation scheme.

In embodiments, the enhancement layer information includes N pieces of enhancement sublayer information. The N pieces of enhancement sublayer information are classified into levels based on importance. The importance indicates a degree of impact of the corresponding enhancement sublayer information on the image. The performing, on the enhancement layer information, channel encoding by using at least one encoding algorithm and performing modulation by using at least one modulation scheme to obtain a third symbol set includes: separately performing channel encoding on the N pieces of enhancement sublayer information by using one of the at least one encoding algorithm to obtain N bit streams, where the encoding algorithm used for the enhancement sublayer information is related to the importance of the enhancement sublayer information; splicing, interleaving, or scrambling the N bit streams to obtain M modulation objects; separately modulating the M modulation objects by using one of the at least one modulation scheme to obtain M symbol sets, where the modulation scheme used for the modulation objects is related to importance of the modulation objects that indicates a degree of impact of the corresponding modulation object; and splicing the M symbol sets to obtain the third symbol set.

In embodiments, the mapping of the plurality of symbol sets to a resource for transmission includes: sending the plurality of symbol sets by using a first frame. The first frame includes: a pilot, a frame header, the control information of the base layer information, the base layer information, the control information of the enhancement layer information, and the enhancement layer information. The enhancement layer information includes the N pieces of enhancement sublayer information. The control information of the enhancement layer information includes N pieces of control sublayer information corresponding to the N pieces of enhancement sublayer information respectively.

According to a second aspect, an embodiment of this application provides an image decoding method. The method includes: receiving a signal carried on a resource, and demapping the signal to obtain a first symbol set corresponding to control layer information, a second symbol set corresponding to base layer information, and a third symbol set corresponding to enhancement layer information; performing demodulation and channel decoding on the first symbol set to obtain the control layer information, where the control layer information includes higher-layer control information, and control information of the base layer information and the enhancement layer information; separately performing demodulation and channel decoding on the second symbol set and the third symbol set based on the control layer information to obtain the base layer information and the enhancement layer information; and obtaining an image based on the base layer information and the enhancement layer information.

In embodiments, the performing demodulation and channel decoding on the first symbol set to obtain the control layer information includes: performing, on the first symbol set, demodulation by using a first demodulation scheme and performing channel decoding by using a first decoding algorithm to obtain the control layer information.

In embodiments, the separately performing demodulation and channel decoding on the second symbol set and the third symbol set based on the control layer information to obtain the base layer information and the enhancement layer information includes: performing, on the second symbol set based on the control layer information, demodulation by using a second demodulation scheme and performing channel decoding by using a second decoding algorithm to obtain the base layer information; and performing, on the third symbol set based on the control layer information, demodulation by using at least one demodulation scheme and performing channel decoding by using at least one decoding algorithm to obtain the enhancement layer information. The at least one demodulation scheme does not include the first demodulation scheme or the second demodulation scheme. The at least one decoding algorithm does not include the first decoding algorithm and the second decoding algorithm.

In embodiments, the performing, on the third symbol set based on the control layer information, demodulation by using at least one demodulation scheme and performing channel decoding by using at least one decoding algorithm to obtain the enhancement layer information includes: splitting the third symbol set based on the control layer information to obtain M symbol sets; separately demodulating the M symbol sets by using one of the at least one demodulation scheme to obtain M demodulation objects, where the demodulation scheme used for the symbol sets is related to importance of the symbol sets that indicates a degree of impact of the symbol sets on the image; descrambling, de-interleaving, or splitting the M demodulation objects to obtain N bit streams; and separately decoding the N bit streams by using one of the at least one decoding algorithm to obtain N pieces of enhancement sublayer information. The decoding algorithm used for the bit streams is related to importance of the bit streams that indicates a degree of impact of the bit streams on the image. The enhancement layer information includes the N pieces of enhancement sublayer information. The N pieces of enhancement sublayer information are classified into levels based on importance. The importance indicates a degree of impact of the corresponding enhancement sublayer information on the image.

In embodiments, the obtaining an image based on the base layer information and the enhancement layer information includes: decoding the base layer information to obtain a restored image; performing information combination, dequantization, inverse transform, and block combination processing on the enhancement layer information to obtain residual information; and obtaining the image based on the restored image and the residual information.

According to a third aspect, an embodiment of this application provides an encoding apparatus. The apparatus includes: a processing module, configured to: perform compression encoding on an image to obtain base layer information; obtain enhancement layer information based on the base layer information and the image; obtain control layer information, where the control layer information includes higher-layer control information, and control information of the base layer information and the enhancement layer information; and separately perform channel encoding and modulation on the control layer information, the base layer information, and the enhancement layer information to obtain a plurality of symbol sets; and a sending module, configured to map the plurality of symbol sets to a resource for transmission.

In embodiments, the processing module is configured to decode the base layer information to obtain a restored image, calculate a residual of the image and the restored image to obtain residual information, and perform partition, transform, and quantization processing on the residual information to obtain the enhancement layer information.

In embodiments, the processing module is configured to: perform, on the control layer information, channel encoding by using a first encoding algorithm and perform modulation by using a first modulation scheme to obtain a first symbol set; perform, on the base layer information, channel encoding by using a second encoding algorithm and perform modulation by using a second modulation scheme to obtain a second symbol set; and perform, on the enhancement layer information, channel encoding by using at least one encoding algorithm and perform modulation by using at least one modulation scheme to obtain a third symbol set. The at least one encoding algorithm does not include the first encoding algorithm and the second encoding algorithm. The at least one modulation scheme does not include the first modulation scheme and the second modulation scheme.

In embodiments, the enhancement layer information includes N pieces of enhancement sublayer information. The N pieces of enhancement sublayer information are classified into levels based on importance. The importance indicates a degree of impact of the corresponding enhancement sublayer information on the image. The processing module is configured to: separately perform channel encoding on the N pieces of enhancement sublayer information by using one of the at least one encoding algorithm to obtain N bit streams, where the encoding algorithm used for the enhancement sublayer information is related to the importance of the enhancement sublayer information; splice, interleave, or scramble the N bit streams to obtain M modulation objects; separately modulate the M modulation objects by using one of the at least one modulation scheme to obtain M symbol sets, where the modulation scheme used for the modulation objects is related to importance of the modulation objects that indicates a degree of impact of the corresponding modulation object; and splice the M symbol sets to obtain the third symbol set.

In embodiments, the sending module is configured to send the plurality of symbol sets by using a first frame. The first frame includes: a pilot, a frame header, the control information of the base layer information, the base layer information, the control information of the enhancement layer information, and the enhancement layer information. The enhancement layer information includes the N pieces of enhancement sublayer information. The control information of the enhancement layer information includes N pieces of control sublayer information corresponding to the N pieces of enhancement sublayer information respectively.

According to a fourth aspect, an embodiment of this application provides a decoding apparatus. The apparatus includes: a receiving module, configured to receive a signal carried on a resource; and a processing module, configured to: demap the signal to obtain a first symbol set corresponding to control layer information, a second symbol set corresponding to base layer information, and a third symbol set corresponding to enhancement layer information; perform demodulation and channel decoding on the first symbol set to obtain the control layer information, where the control layer information includes higher-layer control information, and control information of the base layer information and the enhancement layer information; separately perform demodulation and channel decoding on the second symbol set and the third symbol set based on the control layer information to obtain the base layer information and the enhancement layer information; and obtain an image based on the base layer information and the enhancement layer information.

In embodiments, the processing module is configured to perform, on the first symbol set, demodulation by using a first demodulation scheme and perform channel decoding by using a first decoding algorithm to obtain the control layer information.

In embodiments, the processing module is configured to: perform, on the second symbol set based on the control layer information, demodulation by using a second demodulation scheme and perform channel decoding by using a second decoding algorithm to obtain the base layer information; and perform, on the third symbol set based on the control layer information, demodulation by using at least one demodulation scheme and perform channel decoding by using at least one decoding algorithm to obtain the enhancement layer information. The at least one demodulation scheme does not include the first demodulation scheme and the second demodulation scheme. The at least one decoding algorithm does not include the first decoding algorithm and the second decoding algorithm.

In embodiments, the processing module is configured to: split the third symbol set based on the control layer information to obtain M symbol sets; separately demodulate the M symbol sets by using one of the at least one demodulation scheme to obtain M demodulation objects, where the demodulation scheme used for the symbol sets is related to importance of the symbol sets; descramble, de-interleave, or split the M demodulation objects to obtain N bit streams; and separately decode the N bit streams by using one of the at least one decoding algorithm to obtain N pieces of enhancement sublayer information. The decoding algorithm used for the bit streams is related to importance of the bit streams. The enhancement layer information includes the N pieces of enhancement sublayer information. The N pieces of enhancement sublayer information are classified into levels based on importance. The importance indicates a degree of impact of the corresponding enhancement sublayer information on the image.

In embodiments, the processing module is configured to decode the base layer information to obtain a restored image; perform information combination, dequantization, inverse transform, and block combination processing on the enhancement layer information to obtain residual information; and obtain the image based on the restored image and the residual information.

According to a fifth aspect, an embodiment of this application provides an encoding apparatus, configured to perform any one of the first aspect or the possible embodiments of the first aspect. For details, refer to any one of the first aspect or the possible embodiments of the first aspect. Details are not described herein again.

According to a sixth aspect, an embodiment of this application provides a decoding apparatus, configured to perform any one of the second aspect or the possible embodiments of the second aspect. For details, refer to any one of the second aspect or the possible embodiments of the second aspect. Details are not described herein again.

According to a seventh aspect, an embodiment of this application provides an encoding apparatus. The apparatus includes a processing circuit and an output interface communicating with the processing circuit. The processing circuit is configured to: perform compression encoding on an image to obtain base layer information; obtain enhancement layer information based on the base layer information and the image; obtain control layer information, where the control layer information includes higher-layer control information, and control information of the base layer information and the enhancement layer information; separately perform channel encoding and modulation on the control layer information, the base layer information, and the enhancement layer information to obtain a plurality of symbol sets; and map the plurality of symbol sets to a resource to generate a first frame. The output interface is configured to send the first frame.

According to an eighth aspect, an embodiment of this application provides a decoding apparatus. The apparatus includes a processing circuit and an input interface communicating with the processing circuit. The input interface is configured to receive a first frame. The processing circuit is configured to: demap the first frame to obtain a first symbol set corresponding to control layer information, a second symbol set corresponding to base layer information, and a third symbol set corresponding to enhancement layer information; perform demodulation and channel decoding on the first symbol set to obtain the control layer information, where the control layer information includes higher-layer control information, and control information of the base layer information and the enhancement layer information; separately perform demodulation and channel decoding on the second symbol set and the third symbol set based on the control layer information to obtain the base layer information and the enhancement layer information; and obtain an image based on the base layer information and the enhancement layer information.

According to a ninth aspect, an embodiment of this application provides a computer-readable storage medium, configured to store a computer program. The computer program includes instructions used for performing any one of the first aspect or the possible embodiments of the first aspect.

According to a tenth aspect, an embodiment of this application provides a computer-readable storage medium, configured to store a computer program. The computer program includes instructions used for performing any one of the second aspect or the possible embodiments of the second aspect.

According to an eleventh aspect, an embodiment of this application provides a computer program. The computer program includes instructions used for performing any one of the first aspect or the possible embodiments of the first aspect.

According to a twelfth aspect, an embodiment of this application provides a computer program. The computer program includes instructions used for performing any one of the second aspect or the possible embodiments of the second aspect.

According to a thirteenth aspect, an embodiment of this application provides a communication system. The communication system includes the encoding apparatus provided in the third aspect, the fifth aspect, or the seventh aspect, and the decoding apparatus provided in the fourth aspect, the sixth aspect, or the eighth aspect.

### BRIEF DESCRIPTION OF DRAWINGS

FIG. 1A is a block diagram of an example of a video encoding and decoding system 10 for implementing an embodiment of this application;

FIG. 1B is a block diagram of an example of a video coding system 40 for implementing an embodiment of this application;

FIG. 2 is a block diagram of an example structure of an encoder 20 for implementing an embodiment of this application;

FIG. 3 is a block diagram of an example structure of a decoder 30 for implementing an embodiment of this application;

FIG. 4 is a block diagram of an example of a video coding device 400 for implementing an embodiment of this application;

FIG. 5 is a block diagram of another example of an encoding apparatus or a decoding apparatus for implementing an embodiment of this application;

FIG. 6 is a schematic flowchart of an image encoding and decoding method for implementing this application;

FIG. 7 is a pixel distribution diagram of a 16×16 image;

FIG. 8 is a schematic diagram of transform coefficients;

FIG. 9 is a schematic diagram of quantized transform coefficients;

FIG. 10 is a schematic diagram of a coefficient reading sequence;

FIG. 11 is a schematic diagram of a bit plane;

FIG. 12 is a schematic flowchart of an image encoding and decoding method for implementing this application;

FIG. 13 is a schematic diagram of layers of a data flow according to this application;

FIG. 14 is a schematic block diagram of an encoding apparatus according to an embodiment of this application; and

FIG. 15 is a schematic block diagram of a decoding apparatus according to an embodiment of this application.

### DESCRIPTION OF EMBODIMENTS

The following describes embodiments of this application with reference to the accompanying drawings in embodiments of this application. In the following description, reference is made to the accompanying drawings, which form a part of this disclosure and show, by way of illustration, aspects of embodiments of this disclosure or aspects in which embodiments of this application may be used. It should be understood that embodiments of this disclosure may be used in other aspects, and may include structural or logical changes not depicted in the accompanying drawings. Therefore, the following detailed descriptions shall not be understood in a limiting sense, and the scope of this application is defined by the appended claims. For example, it should be understood that the disclosure, with reference to the described method, may also be applied to a corresponding device or system for performing the method, and vice versa. For example, if one or more method steps are described, a corresponding device may include one or more units such as functional units and/or circuits for performing the described one or more method steps (for example, one unit/circuit performs the one or more steps; or a plurality of units/circuits, each of which performs one or more of the plurality of steps), even if such one or more units are not explicitly described or illustrated in the accompanying drawings. In addition, for example, if an apparatus is described based on one or more units such as a functional unit/functional circuit, a corresponding method may include one step for implementing functionality of one or more units or one or more circuits (for example, one step for implementing functionality of one or more units; or a plurality of steps, each of which is for implementing functionality of one or more units in a plurality of units), even if such one or more of steps are not explicitly described or illustrated in the accompanying drawings. Further, it should be understood that unless otherwise specified, features of the example embodiments and/or aspects described in this application may be combined with each other.

The technical solutions in embodiments of this application may be applied to existing video coding standards (such as H.264 and HEVC), and may also be applied to future video coding standards (such as H.266), and even future communication standards such as cellular and Wi-Fi. Terms used in embodiments of this application are only used for explaining embodiments of this application, but are not intended to limit this application. The following first briefly describes some possible concepts in embodiments of this application.

Video coding usually indicates processing of a sequence of pictures, where the sequence of pictures forms a video or a video sequence. In the field of video coding, the terms “picture”, “frame”, or “image” may be used as synonyms. Video coding in this application indicates video encoding or video decoding. Video encoding is performed on a source side, and usually includes processing (for example, by compressing) an original video picture to reduce an amount of data for representing the video picture, for more efficient storage and/or transmission. Video decoding is performed on a destination side, and usually includes inverse processing relative to an encoder, to reconstruct video pictures. “Coding” of a video picture in embodiments should be understood as “encoding” or “decoding” of a video sequence. A combination of an encoding part and a decoding part is also referred to as encoding and decoding (encoding and decoding).

A video sequence includes a series of pictures, where the picture is further split into slices, and the slice is further split into blocks. In video coding, coding processing is performed per block. In some new video coding standards, a concept “block” is further extended. For example, in the H.264 standard, there is a macroblock (MB), and the macroblock may be further split into a plurality of prediction blocks (e.g., partitions) that can be used for predictive coding. In the high efficiency video coding (HEVC) standard, a plurality of block units are classified based on functions by using basic concepts such as a coding unit (e.g., coding circuit, CU), a prediction unit (e.g., prediction circuit, PU), and a transform unit (e.g., transforming unit, transform circuit, TU), and are described by using a new tree-based structure. For example, a CU may be partitioned into smaller CUs based on a quad-tree, and the smaller CU may be further partitioned, to generate a quad-tree structure. The CU is a basic unit for partitioning and coding a coded picture. A PU and a TU also have a similar tree structure. The PU may correspond to a prediction block and is a basic unit of predictive coding. The CU is further split into a plurality of PUs in a split mode. The TU may correspond to a transform block, and is a basic unit for transforming a prediction residual. However, in essence, all of the CU, the PU, and the TU are conceptually blocks (or image blocks).

For ease of description and understanding, a to-be-encoded image block in a current encoded image may be referred to as a current block. For example, during encoding, the current block is a current encoding block (e.g., the block currently being encoded). During decoding, the current block is a current decoding block (e.g., the block currently being decoded). A decoded image block that is in a reference image and that is for predicting the current block is referred to as a reference block. In other words, the reference block is a block that provides a reference signal for the current block, where the reference signal indicates a pixel value in the image block. A block that provides a prediction signal for a current block in a reference picture may be referred to as a prediction block. The prediction signal represents a pixel value, a sampling value, or a sampling signal in the prediction block. For example, an optimal reference block is found after a plurality of reference blocks are traversed, the optimal reference block provides prediction for the current block, and this block is referred to as a prediction block.

In a case of lossless video coding, original video pictures can be reconstructed. In other words, reconstructed video pictures have same quality as the original video pictures (i.e., assuming that no transmission loss or other data loss occurs during storage or transmission). In a case of lossy video coding (e.g., lossy compression), further compression is performed through, for example, quantization, to reduce an amount of data required for representing video pictures, where the video pictures cannot be completely reconstructed on a decoder side. In other words, a quality of reconstructed video pictures may be lower or poorer than that of the original video pictures.

Several H.261 video coding standards are for “lossy hybrid video codecs” (in other words, spatial and temporal prediction in a sample domain is combined with 2D transform coding for applying quantization in a transform domain). Each picture of a video sequence is usually split into a set of non-overlapping blocks, and encoding is usually performed at a block level. In other words, on an encoder side, a video is typically processed, namely, encoded, at a block (e.g., video block) level, for example, using spatial (e.g., intra-picture) prediction and/or temporal (e.g., inter-picture) prediction to generate a prediction block, subtracting the prediction block from a current block (i.e., a block that is currently being processed or to be processed) to obtain a residual block. Transforming the residual block and quantizing the residual block in the transform domain to reduce an amount of data to be transmitted (e.g., compressed), whereas on a decoder side, inverse processing in comparison with processing of the encoder is applied to the encoded or compressed block to reconstruct the current block for representation. Furthermore, the encoder duplicates a decoder processing loop, so that the encoder and the decoder generate same prediction (for example, intra predictions and inter predictions) and/or reconstruction, for processing, namely, for encoding subsequent blocks.

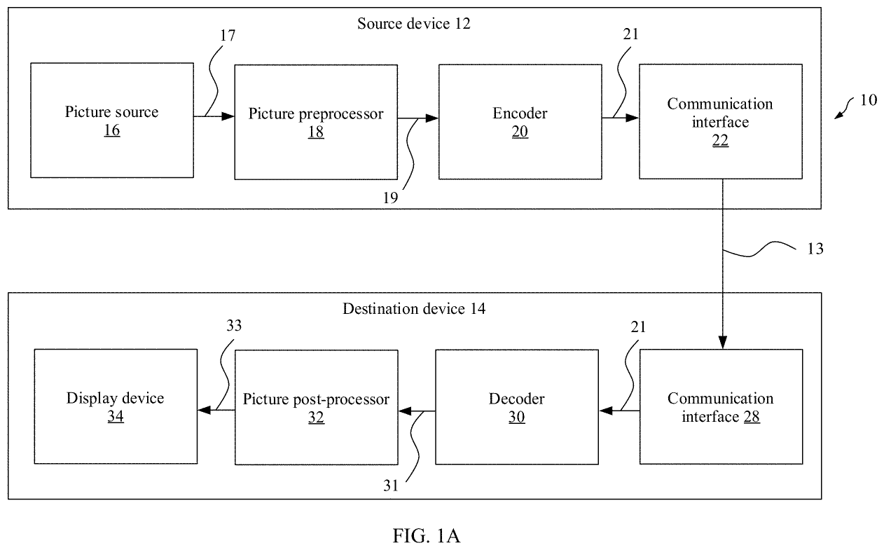

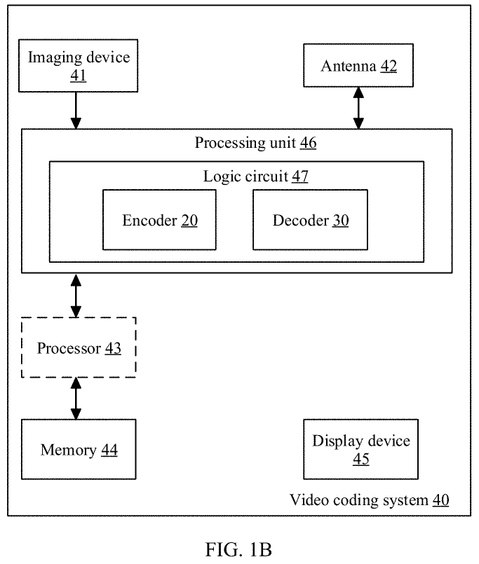

The following describes a system architecture to which embodiments of this application are applied. FIG. 1A is a schematic block diagram of an example of a video encoding and decoding system 10 to which an embodiment of this application is applied. As shown in FIG. 1A, the video encoding and decoding system 10 may include a source device 12 and a destination device 14. The source device 12 generates encoded video data, and therefore the source device 12 may be referred to as a video encoding apparatus. The destination device 14 may decode the encoded video data generated by the source device 12, and therefore the destination device 14 may be referred to as a video decoding apparatus. The source device 12, the destination device 14, or various embodiments of the source device 12 or the destination device 14 may include one or more processors and a memory coupled to the one or more processors. The memory may include but is not limited to a RAM, a ROM, an EEPROM, a flash memory, or any other medium that can store desired program code in a form of instructions or a data structure accessible by a computer, as described in this application. The source device 12 and the destination device 14 may include various apparatuses, including a desktop computer, a mobile computing apparatus, a notebook (for example, a laptop) computer, a tablet computer, a set-top box, a telephone handset such as a “smart” phone, a television, a camera, a display apparatus, a digital media player, a video game console, a vehicle-mounted computer, a wireless communication device, or the like.

Although FIG. 1A depicts the source device 12 and the destination device 14 as separate devices, a device embodiment may alternatively include both the source device 12 and the destination device 14 or functionalities of both the source device 12 and the destination device 14. Namely, the source device 12 or a corresponding functionality and the destination device 14 or a corresponding functionality. In such embodiments, the source device 12 or the corresponding functionality and the destination device 14 or the corresponding functionality may be implemented by using the same hardware and/or software, separate hardware and/or software, or any combination thereof.

A communication connection between the source device 12 and the destination device 14 may be implemented through a link 13, and the destination device 14 may receive encoded video data from the source device 12 through the link 13. The link 13 may include one or more media or apparatuses capable of moving the encoded video data from the source device 12 to the destination device 14. In an example, the link 13 may include one or more communication media that enable the source device 12 to transmit the encoded video data directly to the destination device 14 in real time. In this example, the source device 12 may modulate the encoded video data according to a communication standard (for example, a wireless communication protocol), and may transmit modulated video data to the destination device 14. The one or more communication media may include a wireless communication medium and/or a wired communication medium, for example, a radio frequency (RF) spectrum or one or more physical transmission lines. The one or more communication media may constitute a part of a packet-based network, where the packet-based network is, for example, a local area network (LAN), a wide area network (WAN), or a global network (for example, the internet). The one or more communication media may include a router, a switch, a base station, or another device that facilitates communication from the source device 12 to the destination device 14.

The source device 12 includes an encoder 20. Optionally, the source device 12 may further include a picture source 16, a picture preprocessor 18, and a communication interface 22. In embodiments, the encoder 20, the picture source 16, the picture preprocessor 18, and the communication interface 22 may be hardware components in the source device 12, or may be software programs in the source device 12, or any combination thereof. Descriptions are as follows.

The picture source 16 may include or be any type of picture capture device configured to, for example, capture a real-world picture; and/or any type of device for generating a picture or comment (for screen content encoding, displaying text on a screen is also considered as a part of a to-be-encoded picture or image), for example, a computer graphics processing unit (GPU) configured to generate a computer animation picture; or any type of device for obtaining and/or providing a real-world picture or a computer animation picture (for example, screen content or a virtual reality (VR) picture); and/or any combination thereof (for example, an augmented reality (AR) picture). The picture source 16 may be a camera configured to capture a picture or a memory configured to store a picture. The picture source 16 may further include any type of (e.g., internal or external) interface through which a previously captured or generated picture is stored and/or a picture is obtained or received. When the picture source 16 is a camera, the picture source 16 may be, for example, a local camera, or an integrated camera integrated into the source device. When the picture source 16 is a memory, the picture source 16 may be a local memory or, for example, an integrated memory integrated into the source device. When the picture source 16 includes an interface, the interface may be, for example, an external interface for receiving a picture from an external video source. The external video source is, for example, an external picture capturing device such as a camera, an external memory, or an external picture generation device. The external picture generation device is, for example, an external computer graphics processor, a computer, or a server. The interface may be any type of interface, for example, a wired or wireless interface or an optical interface, according to any proprietary or standardized interface protocol.

A picture may be considered as a two-dimensional array or matrix of picture elements. A pixel in the array may also be referred to as a sample. A quantity of samples in horizontal and vertical directions (or axes) of the array or the picture defines a size and/or resolution of the picture. For representation of a color, three color components are usually employed. In other words, the picture may be represented as or include three sample arrays. For example, in a red-green-blue (RGB) format or color space, a picture includes a corresponding red, green, and blue sample array. However, in video coding, each sample is usually represented in a luminance/chrominance format or color space. For example, a picture in a YUV format includes a luminance component indicated by Y (or sometimes L) and two chrominance components indicated by U and V. The luminance (e.g., luma) component Y represents luminance or gray level intensity (for example, both are the same in a gray-scale picture), and the two chrominance (e.g., chroma) components U and V represent chrominance or color information components. Accordingly, the picture in the YUV format includes a luminance sample array of luminance sample values (i.e., Y) and two chrominance sample arrays of chrominance values (i.e., U and V). Pictures in the RGB format may be transformed or converted to pictures in the YUV format and vice versa. This process is also referred to as color conversion or transform. If a picture is monochrome, the picture may include only a luminance sample array. In embodiments of this application, a picture transmitted by the picture source 16 to a picture processor may also be referred to as raw picture data 17.

The picture preprocessor 18 is configured to receive the raw picture data 17 and perform preprocessing on the raw picture data 17 to obtain a preprocessed picture 19 or preprocessed picture data 19. For example, the picture preprocessor 18 may perform preprocessing: trimming, color format transformation (for example, from the RGB format to the YUV format), color correction, or denoising.

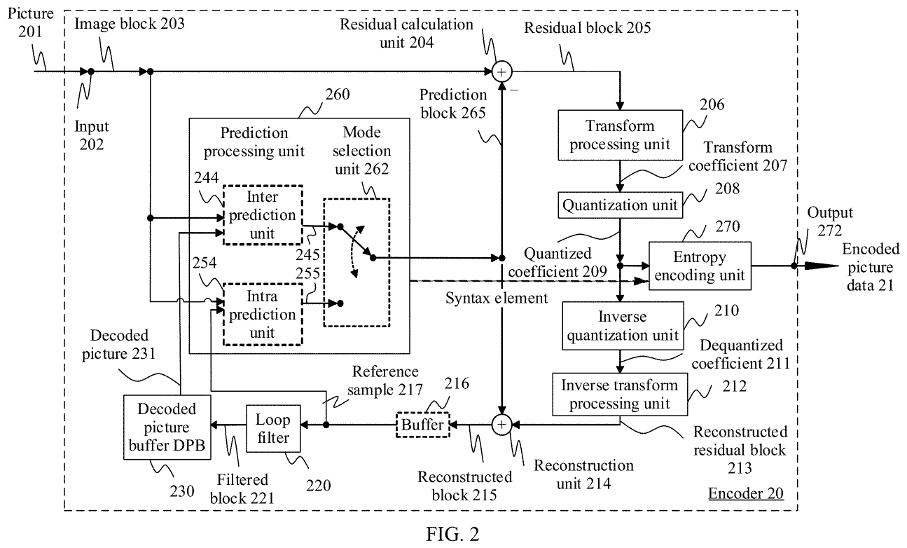

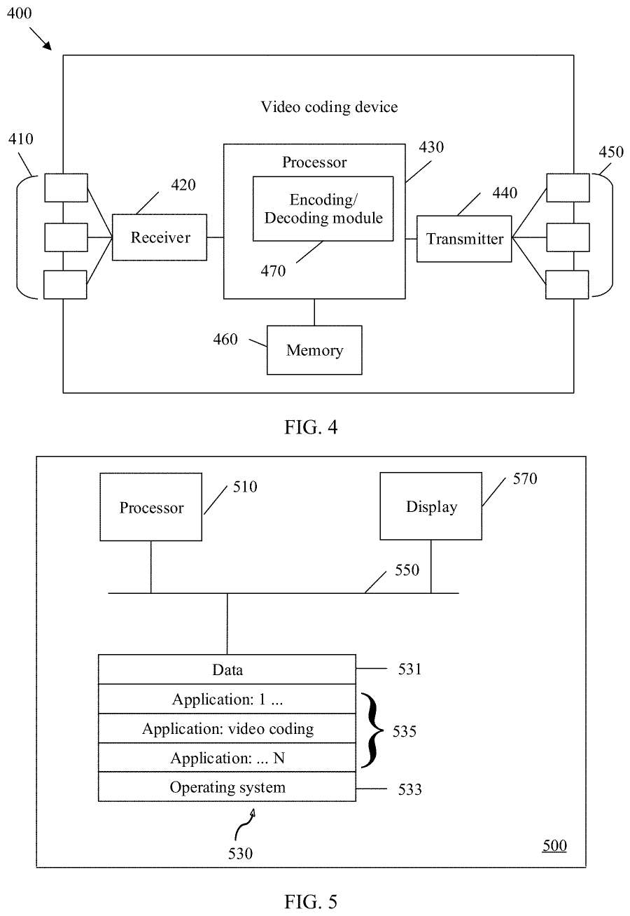

The encoder 20 (also referred to as a video encoder 20) is configured to receive the preprocessed picture data 19, and process the preprocessed picture data 19 in a related prediction mode (such as a prediction mode in embodiments of this application), to provide encoded picture data 21 (the following further describes structural details of the encoder 20 based on FIG. 2, FIG. 4, or FIG. 5).

The communication interface 22 may be configured to receive the encoded picture data 21, and transmit the encoded picture data 21 to the destination device 14 or any other device (for example, a memory) through the link 13 for storage or direct reconstruction. The any other device may be any device for decoding or storage. The communication interface 22 may be, for example, configured to encapsulate the encoded picture data 21 into an appropriate format, for example, a data packet, for transmission over the link 13.

The destination device 14 includes a decoder 30. Optionally, the destination device 14 may further include a communication interface 28, a picture post-processor 32, and a display device 34. Descriptions are as follows.

The communication interface 28 may be configured to receive the encoded picture data 21 from the source device 12 or any other source. The any other source is, for example, a storage device. The storage device is, for example, an encoded picture data storage device. The communication interface 28 may be configured to transmit or receive the encoded picture data 21 through the link 13 between the source device 12 and the destination device 14 or through any type of network. The link 13 is, for example, a direct wired or wireless connection, and the any type of network is, for example, a wired or wireless network or any combination thereof, or any type of private or public network, or any combination thereof. The communication interface 28 may be, for example, configured to decapsulate the data packet transmitted through the communication interface 22, to obtain the encoded picture data 21.

Both the communication interface 28 and the communication interface 22 may be configured as unidirectional communication interfaces or bidirectional communication interfaces, and may be configured to, for example, send and receive messages to establish a connection, and acknowledge and exchange any other information related to a communication link and/or data transmission such as encoded picture data transmission.

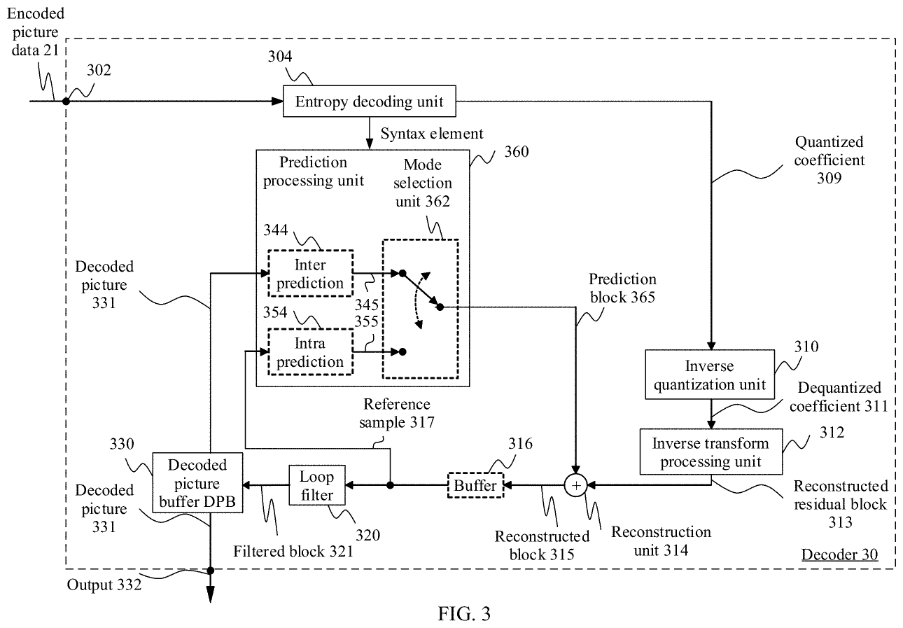

The decoder 30 is configured to receive the encoded picture data 21 and provide decoded picture data 31 or a decoded picture 31 (the following figures further describes and/or illustrates structural details of the decoder 30 based on FIG. 3, FIG. 4, or FIG. 5).

The picture post-processor 32 is configured to post-process the decoded picture data 31 (also referred to as reconstructed picture data) to obtain post-processed picture data 33. The picture post-processor 32 may perform post-processing: color format transformation (for example, from a YUV format to an RGB format), color correction, trimming, re-sampling, or any other processing, and may be further configured to transmit the post-processed picture data 33 to the display device 34.

The display device 34 is configured to receive the post-processed picture data 33 to display a picture, for example, to a user or a viewer. The display device 34 may be or may include any type of display for presenting a reconstructed picture, for example, an integrated or external display or monitor. For example, the display may include a liquid crystal display (LCD), an organic light emitting diode 0 display, a plasma display, a projector, a micro light-emitting diode (LED) display, a liquid crystal on silicon (LCoS), a digital light processor (DLP), or any type of other display.

Although FIG. 1A depicts the source device 12 and the destination device 14 as separate devices, a device embodiment may alternatively include both the source device 12 and the destination device 14 or functionalities of both the source device 12 and the destination device 14, namely, the source device 12 or a corresponding functionality and the destination device 14 or a corresponding functionality. In such embodiments, the source device 12 or the corresponding functionality and the destination device 14 or the corresponding functionality may be implemented by using same hardware and/or software, separate hardware and/or software, or any combination thereof.

A person skilled in the art clearly knows, based on the description, that existence and (an accurate) division of functionalities of different units or the functionalities of the source device 12 and/or the destination device 14 shown in FIG. 1A may vary with an actual device and application. The source device 12 and the destination device 14 may be any one of a wide range of devices, including any type of handheld or stationary device, for example, a notebook or laptop computer, a mobile phone, a smartphone, a pad or a tablet computer, a video camera, a desktop computer, a set-top box, a television set, a camera, a vehicle-mounted device, a display, a digital media player, a video game console, a video streaming transmission device (such as a content service server or a content distribution server), a broadcast receiver device, or a broadcast transmitter device, and may not use or may use any type of operating system.

The encoder 20 and the decoder 30 each may be implemented as any one of various appropriate circuits, for example, one or more microprocessors, digital signal processors (DSPs), application-specific integrated circuits (ASICs), field-programmable gate arrays (FPGAs), discrete logic, hardware, or any combinations thereof. If the technologies are implemented partially by using software, a device may store software instructions in an appropriate and non-transitory computer-readable storage medium and may execute instructions by using hardware such as one or more processors, to perform the technologies of this disclosure. Any of the foregoing content (including hardware, software, a combination of hardware and software, and the like) may be considered as one or more processors.

In some cases, the video encoding and decoding system 10 shown in FIG. 1A is merely an example and the techniques of this application may be applied to video coding settings (for example, video encoding or video decoding) that do not necessarily include any data communication between an encoding device and a decoding device. In another example, data may be retrieved from a local memory, transmitted in a streaming manner through a network, or the like. A video encoding device may encode data and store data into the memory, and/or a video decoding device may retrieve and decode data from the memory. In some examples, encoding and decoding are performed by devices that do not communicate with each other but simply encode data to the memory and/or retrieve data from the memory and decode the data.

FIG. 1B is an illustrative diagram of an example of a video coding system 40 including the encoder 20 in FIG. 2 and/or the decoder 30 in FIG. 3 according to an example embodiment. The video coding system 40 can implement a combination of various technologies in embodiments of this application. In the illustrated embodiment, the video coding system 40 may include an imaging device 41, the encoder 20, the decoder 30 (and/or a video encoder/decoder implemented by using a logic circuit 47 of a processing unit (e.g., a processing circuit) 46), an antenna 42, one or more processors 43, one or more memories 44, and/or a display device 45.

As shown in FIG. 1B, the imaging device 41, the antenna 42, the processing unit 46, the logic circuit 47, the encoder 20, the decoder 30, the processor 43, the memory 44, and/or the display device 45 can communicate with each other. As described, although the video coding system 40 is illustrated with the encoder 20 and the decoder 30, the video coding system 40 may include only the encoder 20 or only the decoder 30 in different examples.

In some examples, the antenna 42 may be configured to transmit or receive a coded bit stream of video data. Further, in some examples, the display device 45 may be configured to present the video data. In some examples, the logic circuit 47 may be implemented by using the processing unit 46. The processing unit 46 may include application-specific integrated circuit (ASIC) logic, a GPU, a general-purpose processor, or the like. The video coding system 40 may also include the optional processor 43. The optional processor 43 may similarly include the ASIC logic, the GPU, the general-purpose processor, or the like. In some examples, the logic circuit 47 may be implemented by using hardware, for example, video coding dedicated hardware, and the processor 43 may be implemented by using general-purpose software, an operating system, or the like. In addition, the memory 44 may be any type of memory, for example, a volatile memory (for example, a static random access memory (SRAM) or a dynamic random access memory (DRAM)) or a non-volatile memory (for example, a flash memory). In a non-limiting example, the memory 44 may be implemented by using a cache memory. In some examples, the logic circuit 47 may access the memory 44 (for example, for implementation of a picture buffer). In other examples, the logic circuit 47 and/or the processing unit 46 may include a memory (for example, a cache) for implementation of a picture buffer or the like.

In some examples, the encoder 20 implemented by using the logic circuit may include a picture buffer (for example, implemented by using the processing unit 46 or the memory 44) and a GPU (for example, implemented by using the processing unit 46). The GPU may be communicatively coupled to the picture buffer. The GPU may include the encoder 20 implemented by using the logic circuit 47, to implement various modules that are described with reference to FIG. 2 and/or any other encoder system or subsystem described in this application. The logic circuit may be configured to perform various operations described in this application.

In some examples, the decoder 30 may be implemented by using the logic circuit 47 in a similar manner, to implement various modules that are described with reference to the decoder 30 in FIG. 3 and/or any other decoder system or subsystem described in this application. In some examples, the decoder 30 implemented by using the logic circuit may include a picture buffer (implemented by using the processing unit 46 or the memory 44) and a GPU (for example, implemented by using the processing unit 46). The GPU may be communicatively coupled to the picture buffer. The GPU may include the decoder 30 implemented by using the logic circuit 47, to implement various modules that are described with reference to FIG. 3 and/or any other decoder system or subsystem described in this application.

In some examples, the antenna 42 may be configured to receive an encoded bit stream of video data. As described, the encoded bit stream may include data, an indicator, an index value, mode selection data, or the like related to video frame encoding described in this application, for example, data related to encoding partitioning (for example, a transform coefficient or a quantized transform coefficient, an optional indicator (as described), and/or data defining the encoding partitioning). The video coding system 40 may further include the decoder 30 that is coupled to the antenna 42 and that is configured to decode the encoded bit stream. The display device 45 is configured to present a video frame.

It should be understood that, in embodiments of this application, for the example described with reference to the encoder 20, the decoder 30 may be configured to perform an inverse process. With regard to signaling a syntax element, the decoder 30 may be configured to receive and parse such a syntax element and correspondingly decode related video data. In some examples, the encoder 20 may perform entropy encoding (e.g., performing a lossless data compression scheme) the syntax element into an encoded video bit stream. In such examples, the decoder 30 may parse such a syntax element and correspondingly decode related video data.

It should be noted that the image encoding and decoding method described in embodiments of this application is mainly used in a joint source and channel encoding and decoding process. This process exists in both the encoder 20 and the decoder 30. The encoder 20 and the decoder 30 in embodiments of this application may be an encoder or a decoder corresponding to a video standard protocol such as H.263, H.264, HEVV, MPEG-2, MPEG-4, VP8, or VP9, or a next-generation video standard protocol (such as H.266).

FIG. 2 is a schematic/conceptual block diagram of an example of an encoder 20 for implementing an embodiment of this application. In the example of FIG. 2, the encoder 20 includes a residual calculation unit (e.g., a residual calculation circuit) 204, a transform processing unit (e.g., a transform processing circuit) 206, a quantization unit (e.g., a quantization circuit) 208, an inverse quantization unit (e.g., an inverse quantization circuit) 210, an inverse transform processing unit (e.g., an inverse transform processing circuit) 212, a reconstruction unit (e.g., a reconstruction circuit) 214, a buffer 216, a loop filter unit (e.g., a loop filter circuit) 220, a decoded picture buffer (DPB) 230, a prediction processing unit (e.g., a prediction processing circuit) 260, and an entropy encoding unit (e.g., an entropy encoding circuit) 270. The prediction processing unit 260 may include an inter prediction unit (e.g., an inter prediction circuit) 244, an intra prediction unit (e.g., an intra prediction circuit) 254, and a mode selection unit (e.g., a mode prediction circuit) 262. The inter prediction unit 244 may include a motion estimation unit (e.g., a motion estimation circuit) and a motion compensation unit (e.g., a motion compensation circuit) (not shown in the diagram). The encoder 20 shown in FIG. 2 may also be referred to as a hybrid video encoder or a video encoder based on a hybrid video codec.

For example, the residual calculation unit 204, the transform processing unit 206, the quantization unit 208, the prediction processing unit 260, and the entropy encoding unit 270 form a forward signal path of the encoder 20, whereas, for example, the inverse quantization unit 210, the inverse transform processing unit 212, the reconstruction unit 214, the buffer 216, the loop filter 220, the DPB 230, and the prediction processing unit 260 form a reverse signal path of the encoder, where the reverse signal path of the encoder corresponds to a signal path of a decoder (refer to a decoder 30 in FIG. 3).

The encoder 20 receives, for example, via an input 202, a picture 201 or an image block 203 of the picture 201, for example, a picture in a sequence of pictures forming a video or a video sequence. The image block 203 may also be referred to as a current picture block or a to-be-encoded picture block, and the picture 201 may be referred to as a current picture or a to-be-encoded picture (particularly in video coding, to distinguish the current picture from other pictures, for example, previously encoded and/or decoded pictures in a same video sequence, namely, the video sequence that also includes the current picture).

An embodiment of the encoder 20 may include a partitioning unit (e.g., a partitioning circuit) (not depicted in FIG. 2), configured to partition the picture 201 into a plurality of blocks such as the image block 203. The picture 201 is usually partitioned into a plurality of non-overlapping blocks. The partitioning unit may be configured to use a same block size for all pictures in a video sequence and a corresponding grid defining the block size, or change a block size between pictures or subsets or picture groups and partition each picture into corresponding blocks.

In one example, the prediction processing unit 260 of the encoder 20 may be configured to perform any combination of the partitioning technologies described above.

Like the picture 201, the image block 203 is also or may be considered as a two-dimensional array or matrix of samples with sample values, although of a smaller size than the picture 201. In other words, the image block 203 may include, for example, one sample array (for example, a luminance array in a case of a monochrome picture 201), three sample arrays (for example, one luminance array and two chrominance arrays in a case of a color picture), or any other quantity and/or type of arrays depending on an applied color format. A quantity of samples in horizontal and vertical directions (or axes) of the image block 203 defines a size of the image block 203.

The encoder 20 shown in FIG. 2 is configured to encode the picture 201 block by block, for example, perform encoding and prediction on each image block 203.

The residual calculation unit 204 is configured to calculate a residual block 205 based on the image block 203 of the picture and a prediction block 265 (further details about the prediction block 265 are provided below), for example, obtain the residual block 205 in a sample domain by subtracting sample values of the prediction block 265 from sample values of the image block 203 of the picture sample by sample (e.g., pixel by pixel).

The transform processing unit 206 is configured to apply a transform, for example, a discrete cosine transform (DCT) or a discrete sine transform (DST), to sample values of the residual block 205 to obtain transform coefficients 207 in a transform domain. The transform coefficients 207 may also be referred to as transform residual coefficients and represent the residual block 205 in the transform domain.

The transform processing unit 206 may be configured to apply integer approximations of DCT/DST, such as transforms specified in HEVC/H.265. Compared with an orthogonal DCT, such integer approximations are usually scaled by a factor. To preserve a norm of a residual block which is processed by using forward and inverse transforms, applying an additional scaling factor is a part of a transform process. The scaling factor is usually chosen based on some constraints, for example, the scale factor being a power of two for a shift operation, a bit depth of the transform coefficient, or a tradeoff between accuracy and implementation costs. For example, a scaling factor may be specified for an inverse transform, for example, by using the inverse transform processing unit 212 on the decoder side (and for a corresponding inverse transform, for example, by using the inverse transform processing unit 212 on the encoder side). Correspondingly, a corresponding scaling factor may be specified for a forward transform, for example, by using the transform processing unit 206 on the encoder side.

The quantization unit 208 is configured to quantize the transform coefficients 207 to obtain quantized transform coefficients 209, for example, through scalar quantization or vector quantization. The quantized transform coefficients 209 may also be referred to as the quantized residual coefficients 209. A quantization process may reduce a bit depth related to a part or all of the transform coefficients 207. For example, an n-bit transform coefficient may be rounded down to an m-bit transform coefficient during quantization, where n is greater than m. A quantization degree may be modified by adjusting a quantization parameter (QP). For example, for scalar quantization, different scales may be applied to achieve finer or coarser quantization. A smaller quantization step corresponds to finer quantization, and a larger quantization step corresponds to coarser quantization. An appropriate quantization step may be indicated by the quantization parameter (QP). For example, the quantization parameter may be an index to a predefined set of appropriate quantization steps. For example, a smaller quantization parameter may correspond to finer quantization (e.g., a smaller quantization step) and a larger quantization parameter may correspond to coarser quantization (e.g., a larger quantization step), or vice versa. The quantization may include division by a quantization step and corresponding quantization or inverse quantization, for example, may be performed through the inverse quantization unit 210, or may include multiplication by a quantization step. Embodiments according to some standards such as HEVC may use the quantization parameter to determine the quantization step. Generally, the quantization step may be calculated based on the quantization parameter by using a fixed point approximation of an equation including division. Additional scaling factors may be introduced for quantization and dequantization, to restore the norm of the residual block, where the norm of the residual block may be modified because of a scale used in the fixed point approximation of the equation for the quantization step and the quantization parameter. In one example embodiment, a scale of the inverse transform may be combined with a scale of dequantization. Alternatively, a customized quantization table may be used and signaled from an encoder to a decoder, for example, in a bit stream. The quantization is a lossy operation, where the loss increases with increasing of the quantization step.

The inverse quantization unit 210 is configured to apply the inverse quantization of the quantization unit 208 to quantized coefficients to obtain dequantized coefficients 211. For example, the inverse quantization unit 210 may apply, based on or by using a same quantization step as the quantization unit 208, the inverse of a quantization scheme applied by the quantization unit 208. The dequantized coefficients 211 may also be referred to as dequantized residual coefficients 211, and correspond, although usually different from the transform coefficients due to a loss caused by quantization, to the transform coefficients 207.

The inverse transform processing unit 212 is configured to apply the inverse transform of the transform applied by the transform processing unit 206, for example, an inverse, DCT or an inverse discrete sine transform (DST), to obtain an inverse transform block 213 in the sample domain. The inverse transform block 213 may also be referred to as an inverse transform dequantized block 213 or an inverse transform residual block 213.

The reconstruction unit 214 (for example, a summer 214) is configured to add the inverse transform block 213 (namely, a reconstructed residual block 213) to the prediction block 265 to obtain a reconstructed block 215 in the sample domain. For example, the reconstruction unit 214 may add sample values of the reconstructed residual block 213 and the sample values of the prediction block 265.

Optionally, a buffer unit 216 (e.g., a buffer circuit, a “buffer” 216 for short), for example, a line buffer 216, is configured to buffer or store the reconstructed block 215 and a corresponding sample value, for example, for intra prediction. In other embodiments, the encoder may be configured to use unfiltered reconstructed blocks and/or corresponding sample values stored in the buffer unit 216 for any type of estimation and/or prediction, for example, intra prediction.

For example, in an embodiment, the encoder 20 may be configured so that the buffer unit 216 is used for storing the reconstructed block 215 for intra prediction and also used for the loop filter unit 220 (not shown in FIG. 2), and/or so that, for example, the buffer unit 216 and the decoded picture buffer 230 form one buffer. In other embodiments, filtered blocks 221 and/or blocks or samples from the decoded picture buffer 230 (the blocks or samples are not shown in FIG. 2) are used as an input or a basis for intra prediction.

The loop filter unit 220 (“loop filter” 220 for short) is configured to filter the reconstructed block 215 to obtain a filtered block 221, so as to smooth pixel transitions or improve video quality. The loop filter unit 220 is intended to represent one or more loop filters including a de-blocking filter, a sample-adaptive offset (SAO) filter, and another filter, for example, a bilateral filter, an adaptive loop filter (ALF), a sharpening or smoothing filter, or a collaborative filter. Although the loop filter unit 220 is shown in FIG. 2 as an in-loop filter, the loop filter unit 220 may be implemented as a post loop filter in other configurations. The filtered block 221 may also be referred to as a filtered reconstructed block 221. The decoded picture buffer 230 may store a reconstructed encoded block after the loop filter unit 220 performs a filtering operation on the reconstructed encoded block.

In an embodiment, the encoder 20 (correspondingly, the loop filter unit 220) may be configured to output a loop filter parameter (such as sample adaptive offset information), for example, directly or after entropy encoding performed by the entropy encoding unit 270 or any other entropy encoding unit, so that, for example, the decoder 30 can receive the same loop filter parameter and apply the same loop filter parameter to decoding.

The decoded picture buffer (DPB) 230 may be a reference picture memory that stores reference picture data for use in video data encoding by the encoder 20. The DPB 230 may be formed by any one of a variety of memory devices, such as a dynamic random access memory (DRAM) (including a synchronous DRAM (SDRAM), a magnetoresistive RAM (MRAM), and a resistive RAM (RRAM)), or another type of memory devices. The DPB 230 and the buffer 216 may be provided by a same memory device or separate memory devices. In an example, the decoded picture buffer (DPB) 230 is configured to store the filtered block 221. The decoded picture buffer 230 may be further configured to store other previously filtered blocks. For example, the DPB 230 may store previously reconstructed and filtered blocks 221, of the same current picture or of different pictures, such as previously reconstructed pictures, and may provide complete previously reconstructed, namely, decoded, pictures (and corresponding reference blocks and samples) and/or a partially reconstructed current picture (and corresponding reference blocks and samples), for example, for inter prediction. In an example, if the reconstructed block 215 is reconstructed without in-loop filtering, the DPB 230 is configured to store the reconstructed block 215.

The prediction processing unit 260, also referred to as a block prediction processing unit 260, is configured to receive or obtain the image block 203 (i.e., a current image block 203 of the current picture 201) and reconstructed picture data, for example, reference samples of the same (e.g., the current) picture from the buffer 216 and/or reference picture data 231 of one or more previously decoded pictures from the decoded picture buffer 230, and to process such data for prediction, namely, to provide the prediction block 265 that may be an inter prediction block 245 or an intra prediction block 255.

The mode selection unit 262 may be configured to select a prediction mode (for example, an intra or inter prediction mode) and/or a corresponding prediction block 245 or 255 to be used as the prediction block 265, for calculation of the residual block 205 and for reconstruction of the reconstructed block 215.

In an embodiment, the mode selection unit 262 may be configured to select the prediction mode (for example, from prediction modes supported by the prediction processing unit 260). The prediction mode provides an optimal match or a minimum residual, where the minimum residual results in better compression for transmission or storage, or provides minimum signaling overhead, where the minimum signaling overheads results in better compression for transmission or storage, or considers or balances both. The mode selection unit 262 may be configured to determine the prediction mode based on rate distortion optimization (rate RDO), in other words, select a prediction mode that provides minimum rate distortion optimization or select a prediction mode for which related rate distortion satisfies at least a prediction mode selection criterion.

The following describes in detail prediction processing performed (for example, by using the prediction processing unit 260) and mode selection performed (for example, by using the mode selection unit 262) in an example of the encoder 20.

As described above, the encoder 20 is configured to determine or select the optimal or optimum prediction mode from a set of (pre-determined) prediction modes. The set of prediction modes may include, for example, an intra prediction mode and/or an inter prediction mode.

A set of intra prediction modes may include 35 different intra prediction modes, for example, non-directional modes such as a DC (or a mean) mode and a planar mode, or directional modes such as those defined in H.265; or may include 67 different intra prediction modes, for example, non-directional modes such as the DC (or the mean) mode and a planar mode, or directional modes such as those defined in H.266 under development.

In embodiments, a set of inter prediction modes depends on available reference pictures (namely, for example, at least a part of decoded pictures stored in the DPB 230, as described above) and other inter prediction parameters, for example, depends on whether an entire reference picture or only a part of the reference picture, for example, a search window region around a region of the current block, is for searching for an optimal matching reference block, and/or for example, depends on whether pixel interpolation such as half-pel and/or quarter-pel interpolation is applied. The set of inter prediction modes may include, for example, an advanced motion vector prediction (AMVP) mode and a merge mode. In embodiments, the set of inter prediction modes may include an improved control point-based AMVP mode and an improved control point-based merge mode in embodiments of this application. In an example, the intra prediction unit 254 may be configured to perform any combination of inter prediction technologies described below.

In addition to the foregoing prediction modes, a skip mode and/or a direct mode may also be used in embodiments of this application.

The prediction processing unit 260 may be further configured to partition the image block 203 into smaller block partitions or subblocks, for example, by iteratively using quad-tree (QT) partitioning, binary-tree (BT) partitioning, ternary-tree (triple-tree, TT) partitioning, or any combination thereof, and perform, for example, prediction on each of the block partitions or subblocks. Mode selection includes selection of a tree structure of the partitioned image block 203 and selection of a prediction mode used for each of the block partitions or subblocks.

The inter prediction unit 244 may include a motion estimation (ME) unit (not shown in FIG. 2) and a motion compensation (MC) unit (not shown in FIG. 2). The ME unit is configured to receive or obtain the image block 203 of the picture (e.g., the current image block 203 of the current picture 201) and a decoded picture 231, or at least one or more previously reconstructed blocks, for example, reconstructed blocks of one or more other/different previously decoded pictures 231, for motion estimation. For example, a video sequence may include the current picture and the previously decoded pictures 31, or in other words, the current picture and the previously decoded pictures 31 may be a part of or form a sequence of pictures forming a video sequence.

For example, the encoder 20 may be configured to select a reference block from a plurality of reference blocks of a same picture or different pictures of a plurality of other pictures and provide, to the motion estimation unit (not shown in FIG. 2), a reference picture and/or provide an offset (e.g., a spatial offset) between a position (e.g., coordinates X and Y) of the reference block and a position of the current block as an inter prediction parameter. This offset is also referred to as a motion vector (MV).

The MC unit is configured to obtain the inter prediction parameter, and perform inter prediction based on or by using the inter prediction parameter, to obtain the inter prediction block 245. Motion compensation performed by the MC unit (not shown in FIG. 2) may include fetching or generating the prediction block based on a motion/block vector determined through motion estimation (possibly performing interpolations for sub-pixel precision). Interpolation filtering may generate additional pixel samples from known pixel samples. This potentially increases a quantity of candidate prediction blocks that may be used for encoding a picture block. Upon receiving a motion vector for a PU of the current picture block, the motion compensation unit 246 may locate a prediction block to which the motion vector points in one reference picture list. The motion compensation unit 246 may further generate syntax elements associated with blocks and video slices, for use by the decoder 30 in decoding picture blocks of the video slice.

The inter prediction unit 244 may transmit the syntax elements to the entropy encoding unit 270, and the syntax elements include the inter prediction parameter (such as indication information of selection of an inter prediction mode used for prediction of the current block after traversal of a plurality of inter prediction modes). In a possible application scenario, if there is only one inter prediction mode, the inter prediction parameter may be alternatively not be carried in the syntax elements. In this case, the decoder 30 may perform decoding directly in a default prediction mode. It can be understood that the inter prediction unit 244 may be configured to perform any combination of inter prediction technologies.

The intra prediction unit 254 is configured to obtain, for example, by receiving, the picture block 203 (the current picture block) and one or more previously reconstructed blocks. For example, the intra prediction unit 254 may obtain reconstructed neighboring blocks, of the same picture for intra estimation. The encoder 20 may be, for example, configured to select an intra prediction mode from a plurality of (predetermined) intra prediction modes.

In embodiments, the encoder 20 may be configured to select the intra prediction mode based on an optimization criterion, for example, based on a minimum residual (for example, an intra prediction mode providing the prediction block 255 that is most similar to the current picture block 203) or minimum rate distortion.

The intra prediction unit 254 is further configured to determine the intra prediction block 255 based on, for example, an intra prediction parameter of the selected intra prediction mode. In any case, after selecting an intra prediction mode for a block, the intra prediction unit 254 is further configured to provide the intra prediction parameter, namely, information indicating the selected intra prediction mode for the block, to the entropy encoding unit 270. In an example, the intra prediction unit 254 may be configured to perform any combination of intra prediction technologies.

The intra prediction unit 254 may transmit syntax elements to the entropy encoding unit 270, and the syntax elements include the intra prediction parameter (such as indication information of selection of an intra prediction mode used for prediction of the current block after traversal of a plurality of intra prediction modes). In a possible application scenario, if there is only one intra prediction mode, the intra prediction parameter may be alternatively not be carried in the syntax elements. In this case, the decoder 30 may perform decoding directly in a default prediction mode.

The entropy encoding unit 270 is configured to apply an entropy encoding algorithm or scheme (for example, a variable length coding (VLC) scheme, a context adaptive VLC (CAVLC) scheme, an arithmetic coding scheme, context adaptive binary arithmetic coding (CABAC), syntax-based context-adaptive binary arithmetic coding (SBAC), probability interval partitioning entropy (PIPE) coding, or another entropy encoding method or technology) to the quantized residual coefficients 209, the inter prediction parameter, the intra prediction parameter, and/or the loop filter parameter individually or jointly (or not at all) to obtain encoded picture data 21 that can be output by an output 272, for example, in a form of an encoded bit stream 21. The encoded bit stream may be transmitted to the video decoder 30, or archived for later transmission or retrieval by the video decoder 30. The entropy encoding unit 270 may be further configured to entropy encode other syntax elements for a current video slice being encoded.

Other structural variations of the video encoder 20 can be used for encoding a video stream. For example, a non-transform based encoder 20 may quantize a residual signal directly without the transform processing unit 206 for some blocks or frames. In another embodiment, the encoder 20 may have the quantization unit 208 and the inverse quantization unit 210 combined into a single unit or a single circuit.

In embodiments of this application, the encoder 20 may be configured to implement an image encoding method described in the following embodiments.

It should be understood that other structural variations of the video encoder 20 can be used for encoding a video stream. For example, for some image blocks or image frames, the video encoder 20 may quantize the residual signal directly without processing by the transform processing unit 206, and correspondingly, without processing by the inverse transform processing unit 212. Alternatively, for some image blocks or image frames, the video encoder 20 does not generate residual data, and correspondingly, there is no need for the transform processing unit 206, the quantization unit 208, the inverse quantization unit 210, and the inverse transform processing unit 212 to perform processing. Alternatively, the video encoder 20 may directly store a reconstructed image block as a reference block, without processing by the filter 220. Alternatively, the quantization unit 208 and the inverse quantization unit 210 in the video encoder 20 may be combined together. The loop filter 220 is optional, and in a case of lossless compression encoding, the transform processing unit 206, the quantization unit 208, the inverse quantization unit 210, and the inverse transform processing unit 212 are optional. It should be understood that in different application scenarios, the inter prediction unit 244 and the intra prediction unit 254 may be used selectively.

FIG. 3 is a schematic/conceptual block diagram of an example of a decoder 30 for implementing an embodiment of this application. The video decoder 30 is configured to receive encoded picture data (for example, an encoded bit stream) 21 encoded by, for example, the encoder 20, to obtain a decoded picture 231. In a decoding process, the video decoder 30 receives video data from the video encoder 20, for example, an encoded video bit stream that represents a picture block of an encoded video slice, and an associated syntax element.

In the example of FIG. 3, the decoder 30 includes an entropy decoding unit (e.g., an entry decoding circuit) 304, an inverse quantization unit (e.g., an inverse quantization circuit) 310, an inverse transform processing unit (e.g., an inverse transform processing circuit) 312, a reconstruction unit 314 (e.g., a reconstruction circuit) (for example, a summer 314), a buffer 316, a loop filter 320, a decoded picture buffer 330, and a prediction processing unit (e.g., a prediction processing circuit) 360. The prediction processing unit 360 may include an inter prediction unit 344, an intra prediction unit 354, and a mode selection unit 362. In some examples, the video decoder 30 may perform a decoding pass generally reciprocal to the encoding pass described with reference to the video encoder 20 in FIG. 2.

The entropy decoding unit 304 is configured to perform entropy decoding on the encoded picture data 21 to obtain, for example, quantized coefficients 309 and/or decoded encoding parameters (not shown in FIG. 3), for example, any one or all of an inter prediction parameter, an intra prediction parameter, a loop filter parameter, and/or other syntax elements (that are decoded). The entropy decoding unit 304 is further configured to forward the inter prediction parameter, the intra prediction parameter, and/or the other syntax elements to the prediction processing unit 360. The video decoder 30 may receive syntax elements at a video slice level and/or a video block level.

The inverse quantization unit 310 may have a same function as the inverse quantization unit 110, the inverse transform processing unit 312 may have a same function as the inverse transform processing unit 212, the reconstruction unit 314 may have a same function as the reconstruction unit 214, the buffer 316 may have a same function as the buffer 216, the loop filter 320 may have a same function as the loop filter 220, and the decoded picture buffer 330 may have a same function as the decoded picture buffer 230.

The prediction processing unit 360 may include an inter prediction unit 344 and an intra prediction unit 354. The inter prediction unit 344 may resemble the inter prediction unit 244 in function, and the intra prediction unit 354 may resemble the intra prediction unit 254 in function. The prediction processing unit 360 is usually configured to perform block prediction and/or obtain a prediction block 365 from the encoded picture data 21, and (explicitly or implicitly) receive or obtain a prediction-related parameter and/or information about a selected prediction mode, for example, from the entropy decoding unit 304.

When the video slice is encoded into an intra encoded (I) slice, the intra prediction unit 354 of the prediction processing unit 360 is configured to generate the prediction block 365 for a picture block of a current video slice based on a signaled intra prediction mode and data that is from a previously decoded block of a current frame or picture. When the video frame is encoded into an inter encoded (namely, B or P) slice, the inter prediction unit 344 (for example, the MC unit) of the prediction processing unit 360 is configured to generate the prediction block 365 for a video block of a current video slice based on a motion vector and another syntax element that is received from the entropy decoding unit 304. For inter prediction, the prediction block may be generated from one of reference pictures in a reference picture list. The video decoder 30 may construct reference frame lists, a list 0 and a list 1, by using a default construction technology based on reference pictures stored in the DPB 330.

The prediction processing unit 360 is configured to determine prediction information for a video block of the current video slice by parsing the motion vector and the another syntax element, and use the prediction information to generate the prediction block for the current video block being decoded. In an example of this application, the prediction processing unit 360 determines, by using some received syntax elements, a prediction mode (for example, intra or inter prediction) for encoding the video block of the video slice, an inter prediction slice type (for example, a B slice, a P slice, or a GPB slice), construction information of one or more of the reference picture lists for the slice, a motion vector for each inter encoded video block of the slice, an inter prediction status of each inter encoded video block of the slice, and other information, to decode the video block of the current video slice. In another example of this disclosure, syntax elements received by the video decoder 30 from a bit stream include a syntax element in one or more of a received adaptive parameter set (APS), a sequence parameter set (SPS), a picture parameter set (PPS), or a slice header.

The inverse quantization unit 310 may be configured to inversely quantize (namely, dequantize) quantized transform coefficients provided in the bit stream and decoded by the entropy decoding unit 304. An inverse quantization process may include: using a quantization parameter calculated by the video encoder 20 for each video block in the video slice, to determine a quantization degree that should be applied and, likewise, an inverse quantization degree that should be applied.

The inverse transform processing unit 312 is configured to apply an inverse transform (for example, the inverse DCT, the inverse integer transform, or a conceptually similar inverse transform process) to transform coefficients to generate residual blocks in a pixel domain.

The reconstruction unit 314 (for example, the summer 314) is configured to add an inverse transform block 313 (namely, a reconstructed residual block 313) to the prediction block 365 to obtain a reconstructed block 315 in a sample domain, for example, by adding sample values of the reconstructed residual block 313 and sample values of the prediction block 365.

The loop filter unit 320 (in an encoding loop or after the encoding loop) is configured to filter the reconstructed block 315 to obtain a filtered block 321, to smooth pixel transitions or improve video quality. In an example, the loop filter unit 320 may be configured to perform any combination of filtering technologies described below. The loop filter unit 320 is intended to represent one or more loop filters including a de-blocking filter, a SAO filter, and another filter, for example, a bilateral filter, an ALF, a sharpening or smoothing filter, or a collaborative filter. Although the loop filter unit 320 is shown in FIG. 3 as an in-loop filter, the loop filter unit 320 may be implemented as a post-loop filter in other configurations.

The decoded video blocks 321 in a given frame or picture are then stored in the decoded picture buffer 330 that stores reference pictures used for subsequent motion compensation.

The decoder 30 is configured to, for example, output the decoded picture 31 by using an output 332, for presentation to a user or viewing by a user.

Other variations of the video decoder 30 may be configured to decode a compressed bit stream. For example, the decoder 30 may generate an output video stream without the loop filter unit 320. For example, a non-transform based decoder 30 may inversely quantize a residual signal directly without the inverse transform processing unit 312 for some blocks or frames. In another embodiment, the video decoder 30 may have the inverse quantization unit 310 and the inverse transform processing unit 312 combined into a single unit or a single circuit.

In embodiments of this application, the decoder 30 is configured to implement an image decoding method described in the following embodiments.

It should be understood that other structural variations of the video decoder 30 can be used for decoding an encoded video bit stream. For example, the video decoder 30 may generate an output video stream without processing by the filter 320. Alternatively, for some image blocks or image frames, the entropy decoding unit 304 of the video decoder 30 does not obtain quantized coefficients through decoding, and correspondingly, there is no need for the inverse quantization unit 310 and the inverse transform processing unit 312 to perform processing. The loop filter 320 is optional, and in a case of lossless compression, the inverse quantization unit 310 and the inverse transform processing unit 312 are optional. It should be understood that in different application scenarios, the inter prediction unit and the intra prediction unit may be used selectively.

It should be understood that on the encoder 20 and the decoder 30 in this application, a processing result for a procedure may be output to a next procedure after being further processed. For example, after a procedure such as interpolation filtering, motion vector derivation, or loop filtering, an operation such as clip or shift is further performed on a processing result of a corresponding procedure.

FIG. 4 is a schematic diagram of a structure of a video coding device 400 (for example, a video encoding device 400 or a video decoding device 400) according to an embodiment of this application. The video coding device 400 is suitable for implementing embodiments described in this application. In an embodiment, the video coding device 400 may be a video decoder (for example, the decoder 30 in FIG. 1A) or a video encoder (for example, the encoder 20 in FIG. 1A). In another embodiment, the video coding device 400 may be one or more components of the decoder 30 in FIG. 1A or the encoder 20 in FIG. 1A.

The video coding device 400 includes an ingress port 410 and a receiver unit (e.g., a receiver circuit, Rx) 420 for receiving data, a processor, a logic unit (e.g., a logic circuit), or a central processing unit (CPU) 430 for processing the data, a transmitter unit (e.g., a receiver circuit, Tx) 440 and an egress port 450 for transmitting the data, and a memory 460 for storing the data. The video coding device 400 may also include an optical-to-electrical (OE) conversion component and an electrical-to-optical (EO) component that are coupled to the ingress port 410, the receiver unit 420, the transmitter unit 440, and the egress port 450, for egress or ingress of optical or electrical signals.

The processor 430 is implemented by using hardware and software. The processor 430 may be implemented as one or more CPU chips, cores (for example, multi-core processors), FPGAs, ASICs, and DSPs. The processor 430 communicates with the ingress port 410, the receiver unit 420, the transmitter unit 440, the egress port 450, and the memory 460. The processor 430 includes a coding module 470 (for example, an encoding module 470 or a decoding module 470). The encoding/decoding module 470 implements embodiments disclosed in this application, to implement a chrominance block prediction method provided in embodiments of this application. For example, the encoding/decoding module 470 implements, processes, or provides various encoding operations. Therefore, the encoding/decoding module 470 substantially improves functions of the video coding device 400 and affects a transformation of the video coding device 400 to a different state. Alternatively, the encoding/decoding module 470 is implemented as instructions stored in the memory 460 and executed by the processor 430.

The memory 460 includes one or more disks, tape drives, and solid state drives (SSDs) and may be used as an overflow data storage device, to store programs when such programs are selected for execution, and to store instructions and data that are read during program execution. The memory 460 may be volatile and/or non-volatile, and may be a read-only memory (ROM), a random access memory (RAM), a random access memory (ternary content-addressable memory, TCAM), and/or a static random access memory (SRAM).

FIG. 5 is simplified block diagram of an apparatus 500 that can be used as any one or two of the source device 12 and the destination device 14 in FIG. 1A according to an example embodiment. The apparatus 500 can implement technologies of this application. In other words, FIG. 5 is a schematic block diagram of an embodiment of an encoding device or a decoding device (e.g., a coding device 500 for short) according to an embodiment of this application. The coding device 500 may include a processor 510, a memory 530, and a bus system 550. The processor and the memory are connected through a bus system. The memory is configured to store instructions. The processor is configured to execute the instructions stored in the memory. The memory of the coding device stores program code. The processor can invoke the program code stored in the memory, to perform the video encoding or decoding method described in this application. To avoid repetition, details are not described herein again.

In embodiments of this application, the processor 510 may be a CPU, or the processor 510 may be another general-purpose processor, a digital signal processor (DSP), an ASIC, a field-programmable gate array (FPGA) or another programmable logic device, a discrete gate or transistor logic device, a discrete hardware component, or the like. The general-purpose processor may be a microprocessor, or the processor may be any conventional processor, or the like.

The memory 530 may include a ROM device or a RAM device. Any other proper type of storage device may also be used as the memory 530. The memory 530 may include code and data 531 accessed by the processor 510 by using a bus 550. The memory 530 may further include an operating system (OS) 533 and an application program 535. The application program 535 includes at least one program that allows the processor 510 to perform the video encoding or decoding method described in this application. For example, the application program 535 may include applications 1 to N, and further includes a video encoding or decoding application (e.g., a video coding application for short) that performs the video encoding or decoding method described in this application.

In addition to a data bus, the bus system 550 may further include a power bus, a control bus, a status signal bus, and the like. However, for clear description, various types of buses in the figure are marked as the bus system 550.

Optionally, the coding device 500 may further include one or more output devices, for example, a display 570. In an example, the display 570 may be a touch display that combines a display and a touch unit that operably senses touch input. The display 570 may be connected to the processor 510 through the bus 550.

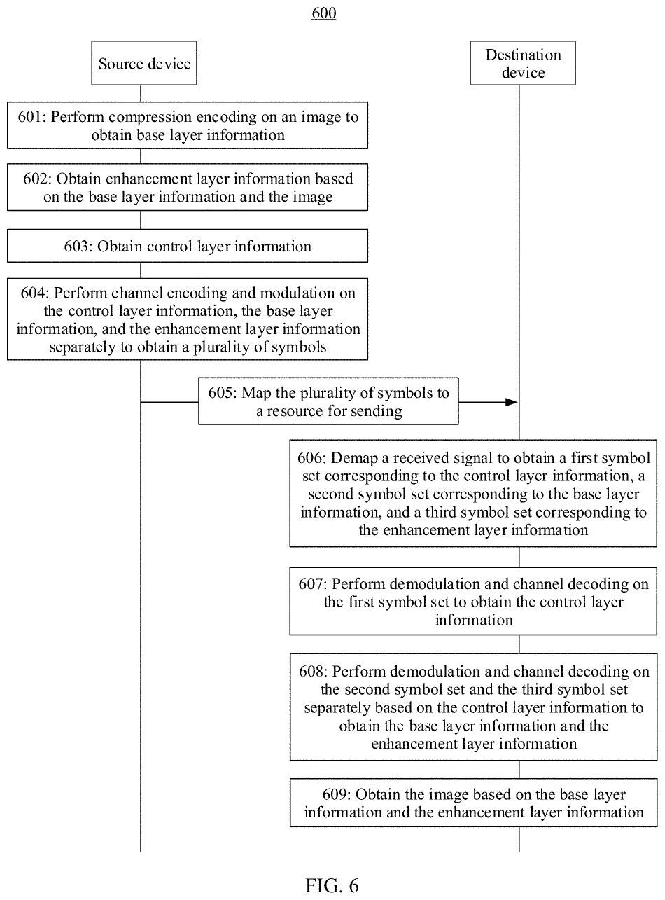

Based on the description of the foregoing embodiment, this application provides an image encoding and decoding method. FIG. 6 is a schematic flowchart of an image encoding and decoding method for implementing this application. The process 600 may be executed by the source device 12 and the destination device 14. The process 600 is described as a series of steps or operations. It should be understood that the steps or operations of the process 600 may be performed in various sequences and/or simultaneously, and are not limited to an execution sequence shown in FIG. 6. As shown in FIG. 6, the method includes the following steps.

Step 601: A source device performs compression encoding on an image to obtain base layer information.

The source device performs source encoding with a high compression rate on the image by using an encoding algorithm such as H.26x, JPEG, or JPEG2000, or by using methods such as image space down-sampling and video frame rate reducing (namely, time-domain down-sampling). For an example of an encoding process, refer to the foregoing description about the encoder. Details are not described herein again.

The obtained base layer information has the following features: (1) The base layer information includes contour or rough information of the image. The user can learn the general meaning conveyed by the original image from an image restored based on the information. (2) The data amount is extremely low. Compared with the bit rate of the original image, the bit rate of the image is reduced by hundreds or even thousands of times. This facilitates subsequent processing through lower-rate and lower-order modulation, and ensures robustness in a transmission process.

It should be noted that a source processed in this application is not limited to an image, and may further include other information such as a video, a voice, and an instruction. This is not limited herein.

Step 602: The source device obtains enhancement layer information based on the base layer information and the image.

The source device decodes the base layer information to obtain the restored image, calculates a residual of the image and the restored image to obtain residual information, and performs partition, transform, and quantization processing on the residual information to obtain the enhancement layer information. A block size may be 8×8, 16×16, 32×32, or the like. The transform may be performed in a manner such as a DCT approach or a discrete wavelet transform (DWT) approach. A uniform or non-uniform quantization table may be used for quantization. For partition, transform, and quantization, refer to descriptions about the image block, the transform processing unit, the quantization unit, and the like in the foregoing embodiments. Details are not described herein again. After the foregoing processing, each transform coefficient obtains a quantized bit stream with a fixed number of bits. These bit streams may be divided into multiple bit planes in descending order of importance by using a bit plane layering technology. For example, a higher-order bit plane is of higher importance, and a lower-order bit plane is of lower importance. In this case, one bit plane may be used as one piece of enhancement sublayer information, or multiple bit planes may be used as one piece of enhancement sublayer information. For example, the following describes a method for obtaining a bit plane in embodiments.

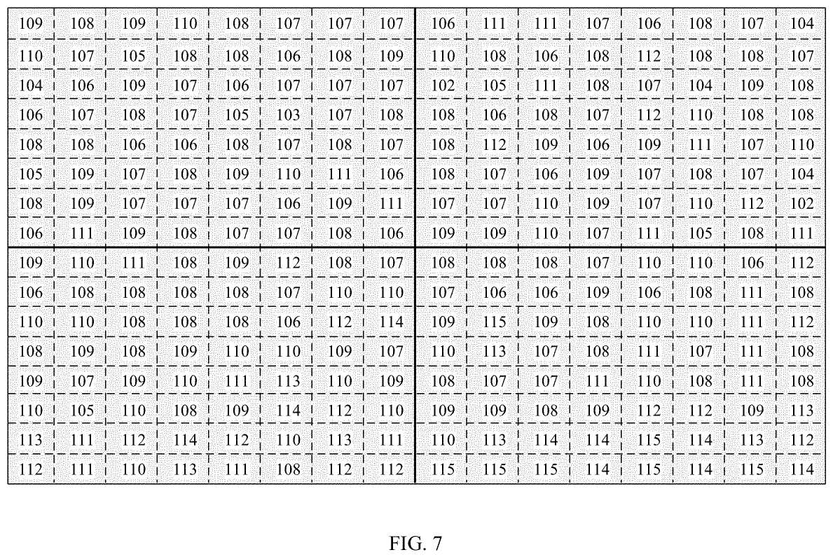

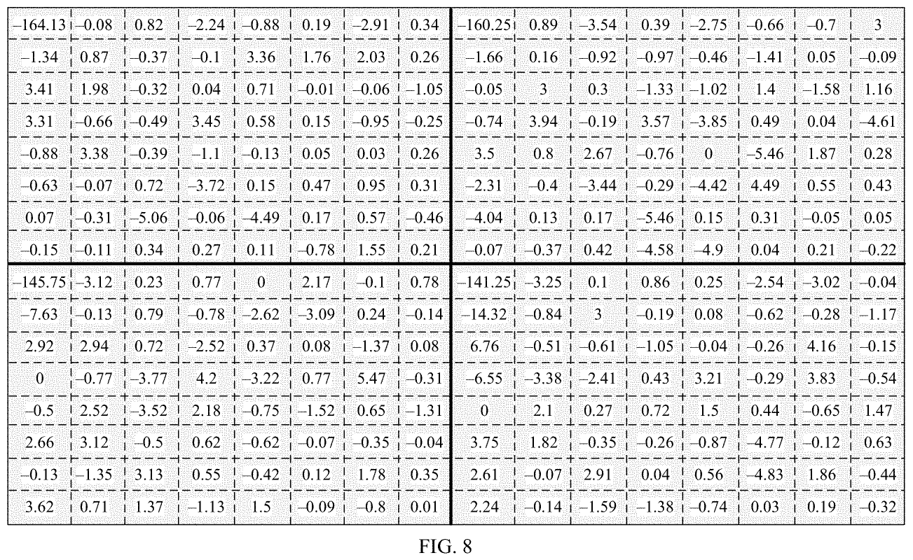

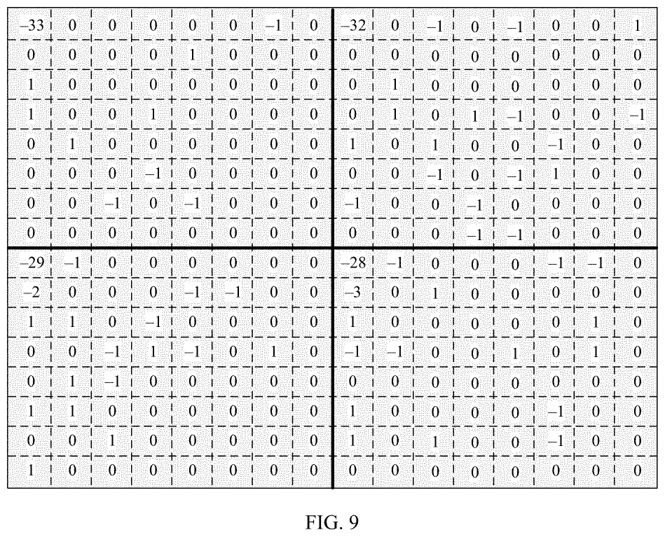

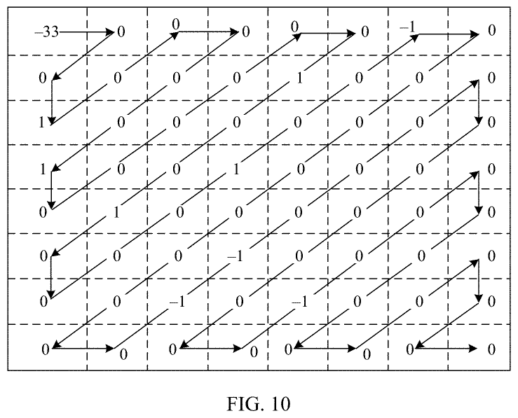

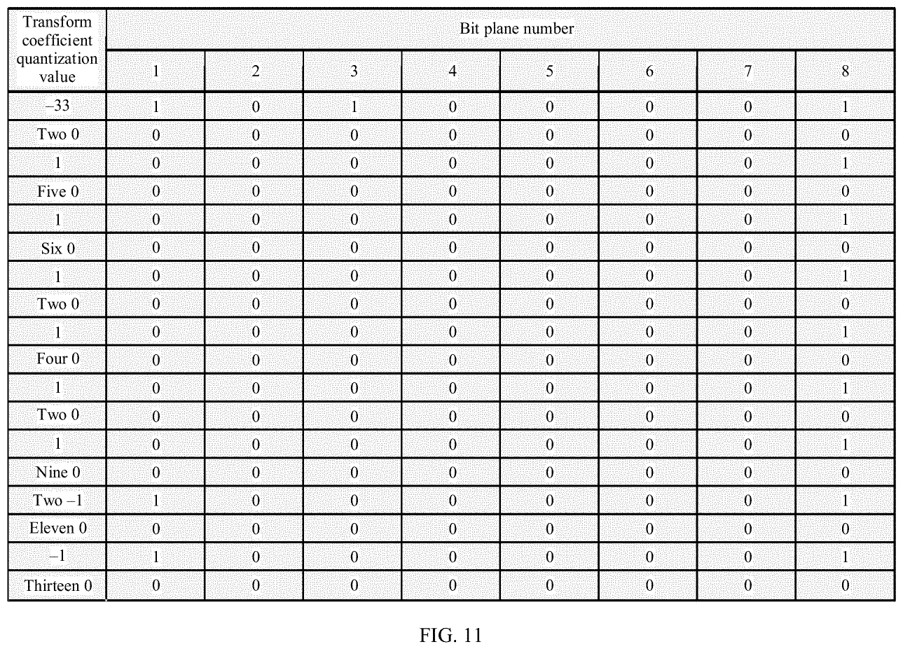

FIG. 7 shows pixel distribution of a 16×16 image. As shown in FIG. 7, each small grid corresponds to one pixel. The image is divided into four 8×8 blocks. Black thick solid lines indicate boundaries of the blocks. Pixel values in each block are offset by −128, and then DCT is performed to obtain transform coefficients shown in FIG. 8. This operation can reduce amplitudes of direct current coefficients in upper left corners of the image, and then reduce a length of binary bits after conversion. Because the transform coefficients in FIG. 8 are all real numbers, and a long binary bit is required for accurate representation. This is not conducive to compression. Therefore, quantization needs to be performed before the transform coefficients are converted into binary. As shown in FIG. 9, assuming that a quantization step is 5, quantized transform coefficients=round (transform coefficients/quantization step 5) may be obtained. Finally, the quantized transform coefficients are converted into a binary bit stream. It is assumed that each transform coefficient is represented by eight bits, the first bit is a sign bit (0 indicates a positive number, and 1 indicates a negative number), and the following seven bits are digital bits. A block in the upper left corner is used as an example. Coefficients in the block are read as a vector in a zigzag order. The reading order is shown by an arrow in FIG. 10. After reading, a binary bit stream corresponding to the transform coefficients in the block is obtained, as shown in FIG. 11. Each column corresponds to one bit plane, and there are eight bit planes (numbered 1 to 8) in total.

Differently from the base layer information, the enhancement layer information is layered mainly through binary conversion of the quantized transform coefficients and splitting of the obtained bit stream into multiple bit planes. The enhancement layer information cannot independently restore a recognizable image, but is used for enhancing visual effect of a base layer based on the base layer information. Through optimization of parameters such as a coding rate and a modulation order of an enhancement layer, smoother channel adaptation effect can be achieved.

Step 603: The source device obtains control layer information.

The control layer information includes voice information and instruction information sent by a higher layer, and further includes control information used in a processing process of the base layer information and the enhancement layer information, for example, a length of the base layer information, a block size of the enhancement layer information, a length of each piece of enhancement sublayer information, before-encoding 0/1 bit probability distribution, a coding rate, a modulation order, a splicing rule indication of bit streams and symbols, and a resource mapping rule indication.

Step 604: The source device performs channel encoding and modulation on the control layer information, the base layer information, and the enhancement layer information separately to obtain a plurality of symbol sets.

The source device performs, on the control layer information, channel encoding by using a first encoding algorithm and performs modulation by using a first modulation scheme to obtain a first symbol set. The source device performs, on the base layer information, channel encoding by using a second encoding algorithm and performs modulation by using a second modulation scheme to obtain a second symbol set.

In this application, the source device may perform encoding and modulation on the control layer information and the base layer information separately by using independent encoding algorithms and modulation schemes at different levels. Based on importance of the control layer information and the base layer information, a lower-rate encoding algorithm and a lower-order modulation scheme (for example, 1/2Rate or binary phase shift keying (BPSK)) may be used for the control layer information and the base layer information. It should be noted that the first encoding algorithm and the second encoding algorithm may be a same algorithm or may be different algorithms, and the first modulation scheme and the second modulation scheme may be a same modulation scheme or may be different modulation schemes. This is not limited in this application.

The source device performs, on the enhancement layer information, channel encoding by using at least one encoding algorithm and performs modulation by using at least one modulation scheme to obtain a third symbol set. The at least one encoding algorithm does not include the first encoding algorithm and the second encoding algorithm. The at least one modulation scheme does not include the first modulation scheme and the second modulation scheme. In other words, channel encoding is performed on N pieces of enhancement sublayer information separately by using one of the at least one encoding algorithm to obtain N bit streams. The encoding algorithm used for the enhancement sublayer information is related to importance of the enhancement sublayer information. Then, the N bit streams are spliced, interleaved, or scrambled to obtain M modulation objects. The M modulation objects are modulated separately by using one of the at least one modulation scheme to obtain M symbol sets. The modulation scheme used for the modulation objects is related to importance of the modulation objects. The M symbol sets are spliced to obtain the third symbol set. It should be noted that the at least one encoding algorithm may alternatively include the first encoding algorithm and/or the second encoding algorithm, and the at least one modulation scheme may alternatively include the first modulation scheme and/or the second modulation scheme. This is not limited herein.

The source device performs encoding and modulation on the N pieces of enhancement sublayer information included in the enhancement layer information separately by using independent encoding algorithms and modulation schemes at different levels. A medium-rate encoding algorithm and a medium-order modulation scheme (e.g., such as 3/4Rate and 16QAM) are used for the enhancement sublayer information corresponding to the higher-order bit plane. A higher-rate encoding algorithm and a higher-order modulation scheme (e.g., such as 7/8Rate and 64QAM) are used for the enhancement sublayer information corresponding to the lower-order bit plane. The bit streams obtained after the N pieces of enhancement sublayer information are separately encoded are spliced, interleaved, and scrambled, and are then mapped to M different constellation diagrams (M≥1) to obtain M modulation objects. Interleaving may enhance a capability of signals to resist sudden channel errors. Scrambling may ensure more even 0/1 bit distribution and stability of instantaneous power of transmitted signals.

Step 605: The source device maps the plurality of symbol sets to a resource for sending to the destination device. The source device splices the plurality of symbol sets (including the first symbol set, the second symbol set, and the third symbol set) obtained after the encoding and modulation, and maps, according to a rule, the symbol sets to a time-domain, frequency-domain, or space-domain resource (e.g., a multi-antenna system) for sending, to further improve transmission reliability. Table 1 shows a format of a frame of the plurality of symbol sets. As shown in Table 1, the frame includes a pilot, a frame header, the control information (e.g., control layer information 0) of the base layer information, the base layer information, the control information of the enhancement layer information, and the enhancement layer information. The enhancement layer information includes the N pieces of enhancement sublayer information (1−N). The control information of the enhancement layer information includes N pieces of control sublayer information (1−N) corresponding to the N pieces of enhancement sublayer information respectively.

TABLE 1

| | | | | | | | | | |
|---|---|---|---|---|---|---|---|---|---|
| Pilot | Frame | Control | Base | Control | Enhancement | . . . | Control | Enhancement | . . . |
| | header | layer | layer | layer | sublayer | | layer | sublayer | |
| | | information 0 | information | information 1 | information 1 | | information N | information N | |

Step 606: The destination device demaps a received signal to obtain the first symbol set corresponding to the control layer information, the second symbol set corresponding to the base layer information, and the third symbol set corresponding to the enhancement layer information.

After performing synchronization, channel estimation, and equalization processing on the received signal, the destination device performs demapping to obtain the symbol sets corresponding to the control layer information, the base layer information, and the enhancement layer information respectively.

Step 607: The destination device performs demodulation and channel decoding on the first symbol set to obtain the control layer information. The destination device performs, on the first symbol set corresponding to the control layer information, demodulation by using a first demodulation scheme and performs channel decoding by using a first decoding algorithm to obtain the control layer information. The control layer information includes higher-layer control information, and the control information of the base layer information and the enhancement layer information.

Step 608: The destination device performs demodulation and channel decoding on the second symbol set and the third symbol set separately based on the control layer information to obtain the base layer information and the enhancement layer information.

The destination device performs, on the second symbol set based on the control layer information, demodulation by using a second demodulation scheme and performs channel decoding by using a second decoding algorithm to obtain the base layer information; and performs, on the third symbol set, demodulation by using at least one demodulation scheme and performs channel decoding by using at least one decoding algorithm to obtain the enhancement layer information. The at least one demodulation scheme does not include the first demodulation scheme and the second demodulation scheme. The at least one decoding algorithm does not include the first decoding algorithm and the second decoding algorithm.

The target device may perform demodulation and decoding on the control layer information, the base layer information, and the enhancement layer information separately by using independent demodulation schemes and decoding algorithms of different levels. The target device performs inverse processing on the source device. Therefore, the demodulation scheme and the decoding algorithm used by the target device for the control layer information, the base layer information, and the enhancement layer information correspond to the modulation scheme and the encoding algorithm used by the source device. For example, the first encoding algorithm corresponds to the first decoding algorithm, the second encoding algorithm corresponds to the second decoding algorithm, the first modulation scheme corresponds to the first demodulation scheme, and the second modulation scheme corresponds to the second demodulation scheme.

For the enhancement layer information, the destination device splits the third symbol set based on the control layer information to obtain the M symbol sets; demodulates the M symbol sets separately by using one of the at least one demodulation scheme to obtain M demodulation objects, where the demodulation scheme used for the symbol sets is related to importance of the symbol sets; descrambles, de-interleaves, or splits the M demodulation objects to obtain N bit streams; and finally decodes the N bit streams separately by using one of the at least one decoding algorithm to obtain the N pieces of enhancement sublayer information. The decoding algorithm used for the bit streams is related to importance of the bit streams. The enhancement layer information includes the N pieces of enhancement sublayer information. The N pieces of enhancement sublayer information are classified into levels based on the importance. The importance indicates a degree of impact of the corresponding enhancement sublayer information on the image.

Step 609: The destination device obtains the image based on the base layer information and the enhancement layer information.

The destination device decodes the base layer information to obtain the restored image, performs information combination, dequantization, inverse transform, and block combination processing on the enhancement layer information to obtain residual information, and finally obtains the image based on the restored image and the residual information. The destination device may obtain soft information corresponding to parity bits through symbol splitting, demodulation, and the like, perform channel decoding by using a confidence transmission method (e.g., using the before-encoding 0/1 bit probability distribution in the control layer information as an initial iteration value) to obtain a 0/1 bit probability of an original bit stream, then perform transform coefficient reconstruction and inverse transform based on the probability to restore original residual information, and combines the residual information and the restored image to obtain the original image.

In an image encoding and decoding process, the source device first performs information layering on a source based on importance and usage. Herein, the source is not limited to an image/video, but may also include other information such as a voice and an instruction. The layering operation mainly includes two levels: First, the base layer and the residual information are obtained through source encoding with a high compression rate, and then the residual information is further layered to obtain several pieces of enhancement sublayer information, to finally generate one piece of base layer information, several pieces of enhancement sublayer information, and one piece of control layer information. Information bits at different layers have different importance, and different encoding and modulation processing are performed on the information bits, mainly including operations such as channel encoding, bit stream splicing, interleaving, and scrambling, modulation, and symbol sequence splicing. Finally, symbols obtained at different layers are mapped to designated resource blocks for sending.

The destination device performs synchronization, channel estimation, and equalization processing on the received signal. Then, the base layer information, the enhancement layer information, and the control layer information are obtained through resource demapping. The base layer information and the control layer information are directly obtained through operations such as demodulation and channel decoding. The enhancement layer information obtains soft information through symbol splitting and demodulation, then performs channel decoding by using the confidence transmission method to obtain the 0/1 bit probability, and performs information combination based on the probability to restore the residual information. Finally, the base layer information and the residual information are combined to obtain an original signal source.

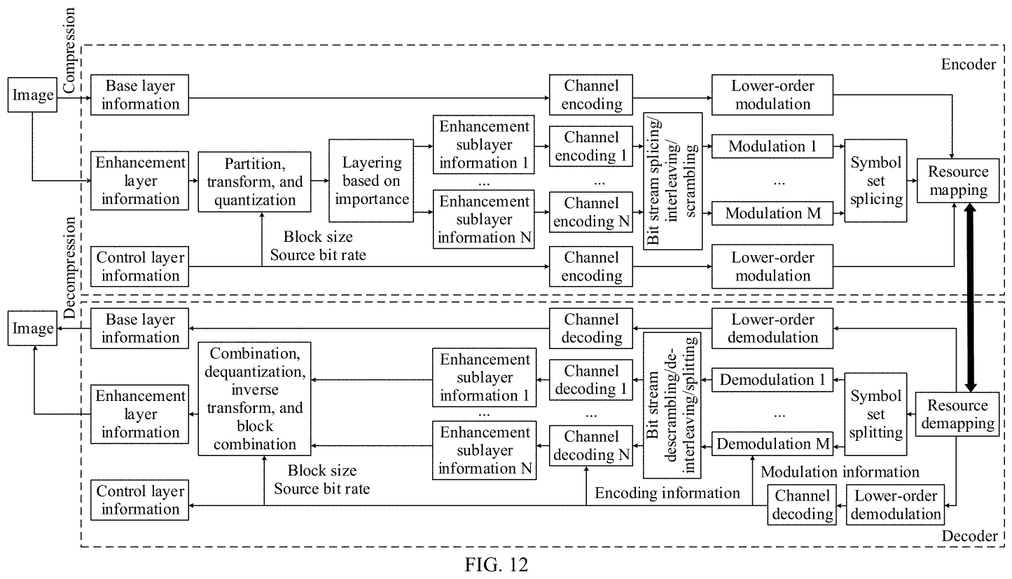

With reference to a source device, a destination device, and a channel between the source device and the destination device, FIG. 12 is a schematic flowchart of an image encoding and decoding method for implementing this application. As shown in FIG. 12, an encoder in the source device compresses an image/a video at a high compression rate to obtain base layer information and residual information, and performs channel encoding and lower-order modulation (for example, Pi/2-BPSK modulation) on the base layer information. Residual frame division, transform, and quantization are performed on the residual information based on the control layer information. Then, layering is performed based on importance to obtain N pieces of enhancement sublayer information. Channel encoding, bit stream splicing, interleaving, and scrambling, modulation, and symbol set splicing are performed on the N pieces of enhancement sublayer information separately. Channel encoding and lower-order modulation (for example, Pi/2-BPSK modulation) are also performed on the control layer information. Finally, modulated symbols are mapped to a resource.

A decoder in the destination device demaps a received signal, and performs demodulation and decoding on symbols corresponding to the base layer information and symbols corresponding to the control layer information separately, to obtain the base layer information and the control layer information. Symbols corresponding to the enhancement layer information are first split and demodulated separately. A bit stream is descrambled, de-interleaved, and split and then decoded separately. Information combination, de-quantization, inverse transform, and block combination are performed to obtain the residual information. The decompressed base layer information and the residual information are combined to obtain an image.

In this application, the base layer information that is obtained after a source is encoded, residual information that is between the original source and the base layer information and that is used as the enhancement layer information, and the control layer information that is generated in a processing process and that is from a higher layer are combined. Independent and different encoding/decoding algorithms and modulation/demodulation schemes are used. The base layer information includes contour or rough information of the image. A user can learn the general meaning conveyed by the original image from an image restored based on the information. In addition, the base layer information has a small data amount and has a bit rate hundreds or even thousands of times less than that of the original source. Therefore, a lower-rate encoding/decoding algorithm and a lower-order modulation/demodulation scheme may be used for completing subsequent processing, to ensure robustness in a transmission process. The enhancement layer information cannot independently restore a recognizable image, but is used for enhancing visual effect of a base layer based on the base layer information. Based on the importance of the enhancement sublayer information of the enhancement layer information, compared with those for the base layer information, a higher-rate encoding/decoding algorithm and a higher-order modulation/demodulation scheme are used for completing the subsequent processing. The control layer information includes the higher-layer control information, and the control information used in a processing process of the base layer information and the enhancement layer information. Based on importance of the control layer information, the lower-rate encoding/decoding algorithm and the lower-order modulation/demodulation scheme may alternatively be used for completing the subsequent processing, to ensure robustness in the transmission process. In this layered processing manner, a to-be-compressed information bit stream with higher sparsity can be obtained, to help improve overall compression efficiency and performance.

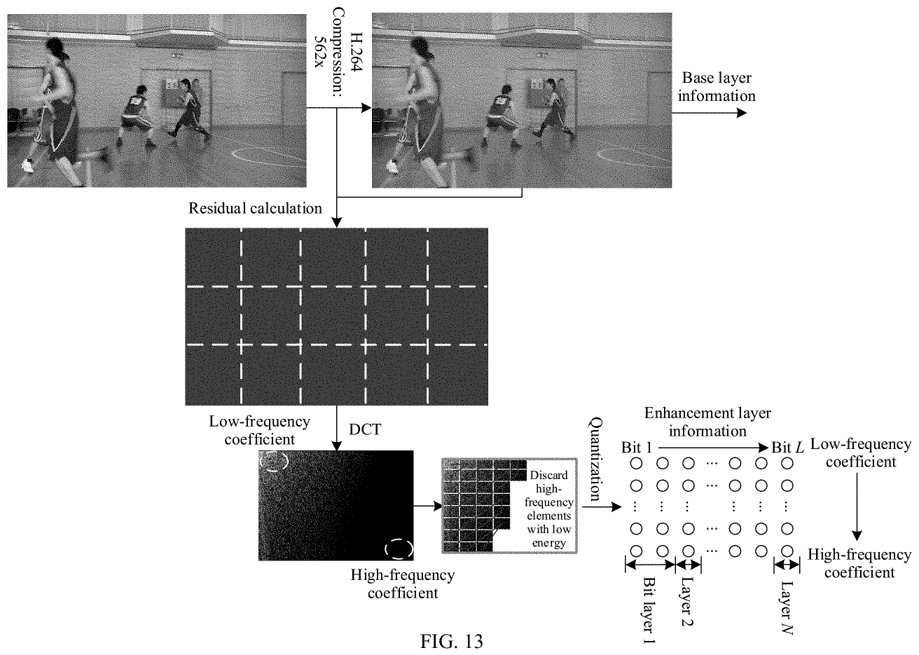

FIG. 13 is a schematic diagram of layers of a data flow according to this application. As shown in FIG. 13, a source device compresses an original video (for example, 1080P, 60 fps) by 562 times by using an H.264 encoder based on a large quantization step, for example, a quantization step of 104 corresponding to a quantization parameter QP=44, to obtain base layer information. Then, the source device decodes the base layer information, and calculates a residual between the base layer information and the original video to obtain residual information. The residual information is further divided into several 8×8 blocks. DCT is performed on each block in sequence to obtain frequency-domain transform coefficients: low-frequency coefficients to high-frequency coefficients from the upper left corner to the lower right corner. Because energy is generally concentrated in a lower-frequency part, some high-frequency coefficients with small energy may be directly discarded. Then, the source device performs a quantization operation on a reserved transform coefficient x to obtain a quantized coefficient x_{quant}=round(x/Qₛₜₑₚ), where Qₛₜₑₚ is a selected quantization step, and X_{quant} quant is an integer. The quantized coefficient x_{quant} may be converted into binary bits to obtain a bit sequence with a width of L, where a value of L is determined by a maximum value range of x_{quant} The bit sequence may be split into N bit layers from a high bit to a low bit, and the N bit layers correspond to N enhancement layers in sequence. To control an overall source compression rate, the following may be implemented by adjusting a bit stream length of the base layer information and a bit stream length of the enhancement layer information separately. (1) Base layer adjustment and control means: Adjustment is performed based on a quantization order, a spatial resolution, and a temporal resolution of a source encoder. A higher quantization order and a lower spatial/temporal resolution indicate a shorter bit stream length and a higher compression rate. (2) Enhancement layer adjustment and control means: Adjustment is performed based on the quantization step Qₛₜₑₚ a proportion of a quantity of the high-frequency coefficients discarded in a frequency domain, and a subsequent joint coding rate. A larger quantization step, a higher proportion of the quantity of the high-frequency coefficients discarded in the frequency domain, and a higher subsequent joint coding rate indicate a shorter bit stream length and a higher compression rate.

The destination device may reconstruct the transform coefficient by using two methods: hard reconstruction and soft reconstruction.

(1) Hard reconstruction: The destination device directly performs hard determination on a 0/1 bit probability of an original bit sequence obtained through channel decoding. In other words, it is determined that the 0/1 bit probability is 0 when p (0)>0.5, and that the 0/1 bit probability is 1 when p (0)<0.5. Then, a value of the reconstructed transform coefficient is calculated based on the determined bit sequence.

(2) Soft reconstruction: The destination device calculates, based on a probability obtained through coding, the transform coefficient as follows:

$$\{ \begin{matrix}{\sum }_{i = 2}^{I} ( {p}_{i} ( 1 ) \times {2}^{I - i} + {p}_{i} ( 0 ) \times 0 ) & {p}_{1} ( 0 ) > 0.5 \\ - {\sum }_{i = 2}^{I} ( {p}_{i} ( 1 ) \times {2}^{I - i} + {p}_{i} ( 0 ) \times 0 ) & {p}_{1} ( 1 ) > 0.5\end{matrix}$$

Herein, I is a quantity of bits for binary quantization of the transform coefficient, the first bit is a sign bit, and the following bits are digital bits, and p₁(b) is a probability that the i^{th} bit is b (b=0, 1). Compared with the hard reconstruction method, the soft reconstruction method has a stronger adaptability to a channel, and can more smoothly reflect impact caused by channel noise.

The foregoing describes the image encoding and decoding methods in embodiments of this application. The following describes apparatuses in embodiments of this application. The apparatuses in embodiments of this application include an encoding apparatus for a transmit end and a decoding apparatus for a receive end. It should be understood that the encoding apparatus for the transmit end is the source device in the foregoing method, and has any function of the transmit end in the foregoing method. The decoding apparatus for the receive end is the destination device in the foregoing method, and has any function of the receive end in the foregoing method.

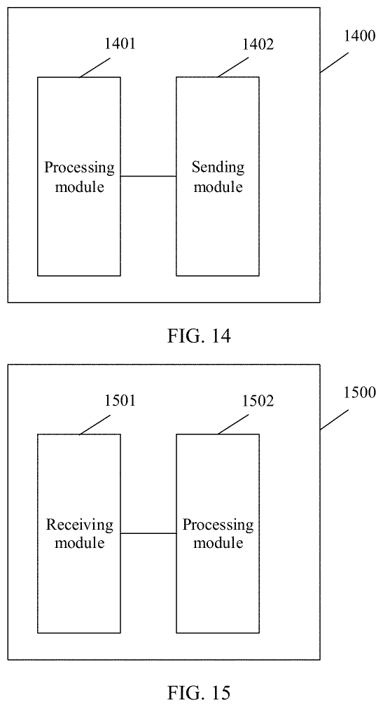

As shown in FIG. 14, the encoding apparatus for the transmit end includes a processing module 1401 and a sending module 1402. The processing module 1401 is configured to: perform compression encoding on an image to obtain base layer information; obtain enhancement layer information based on the base layer information and the image; obtain control layer information, where the control layer information includes higher-layer control information, and control information of the base layer information and the enhancement layer information; and perform channel encoding and modulation on the control layer information, the base layer information, and the enhancement layer information separately to obtain a plurality of symbol sets. The sending module 1402 is configured to map the plurality of symbol sets to a resource for sending.

In embodiments, the processing module 1401 is configured to decode the base layer information to obtain a restored image, calculate a residual of the image and the restored image to obtain residual information, and perform partition, transform, and quantization processing on the residual information to obtain the enhancement layer information.

In embodiments, the processing module 1401 is configured to: perform, on the control layer information, channel encoding by using a first encoding algorithm and perform modulation by using a first modulation scheme to obtain a first symbol set; perform, on the base layer information, channel encoding by using a second encoding algorithm and perform modulation by using a second modulation scheme to obtain a second symbol set; and perform, on the enhancement layer information, channel encoding by using at least one encoding algorithm and perform modulation by using at least one modulation scheme to obtain a third symbol set. The at least one encoding algorithm does not include the first encoding algorithm and the second encoding algorithm. The at least one modulation scheme does not include the first modulation scheme and the second modulation scheme.

In embodiments, the enhancement layer information includes N pieces of enhancement sublayer information. The N pieces of enhancement sublayer information are classified into levels based on importance. The importance indicates a degree of impact of the corresponding enhancement sublayer information on the image. The processing module 1401 is configured to: perform channel encoding on the N pieces of enhancement sublayer information separately by using one of the at least one encoding algorithm to obtain N bit streams, where the encoding algorithm used for the enhancement sublayer information is related to the importance of the enhancement sublayer information; splice, interleave, or scramble the N bit streams to obtain M modulation objects; modulate the M modulation objects separately by using one of the at least one modulation scheme to obtain M symbol sets, where the modulation scheme used for the modulation objects is related to importance of the modulation objects; and splice the M symbol sets to obtain the third symbol set.

In embodiments, the sending module 1402 is configured to send the plurality of symbol sets by using a first frame. The first frame includes: a pilot, a frame header, the control information of the base layer information, the base layer information, the control information of the enhancement layer information, and the enhancement layer information. The enhancement layer information includes the N pieces of enhancement sublayer information. The control information of the enhancement layer information includes N pieces of control sublayer information corresponding to the N pieces of enhancement sublayer information respectively.

The encoding apparatus for the transmit end provided in embodiments of this application is the source device in the foregoing method, and has any function of the transmit end in the foregoing method. For details, refer to the foregoing method. Details are not described herein again.

As shown in FIG. 15, the decoding apparatus for the receive end includes: a receiving module 1501 and a processing module 1502. The receiving module 1501 is configured to receive a signal carried on a resource. The processing module 1502 is configured to: demap the signal to obtain a first symbol set corresponding to control layer information, a second symbol set corresponding to base layer information, and a third symbol set corresponding to enhancement layer information; perform demodulation and channel decoding on the first symbol set to obtain the control layer information, where the control layer information includes higher-layer control information, and control information of the base layer information and the enhancement layer information; perform demodulation and channel decoding on the second symbol set and the third symbol set separately based on the control layer information to obtain the base layer information and the enhancement layer information; and obtain an image based on the base layer information and the enhancement layer information.

In embodiments, the processing module 1502 is configured to perform, on the first symbol set, demodulation by using a first demodulation scheme and perform channel decoding by using a first decoding algorithm to obtain the control layer information.

In embodiments, the processing module 1502 is configured to: perform, on the second symbol set based on the control layer information, demodulation by using a second demodulation scheme and perform channel decoding by using a second decoding algorithm to obtain the base layer information; and perform, on the third symbol set based on the control layer information, demodulation by using at least one demodulation scheme and perform channel decoding by using at least one decoding algorithm to obtain the enhancement layer information. The at least one demodulation scheme does not include the first demodulation scheme and the second demodulation scheme. The at least one decoding algorithm does not include the first decoding algorithm and the second decoding algorithm.

In embodiments, the processing module 1502 is configured to: split the third symbol set based on the control layer information to obtain M symbol sets; demodulate the M symbol sets separately by using one of the at least one demodulation scheme to obtain M demodulation objects, where the demodulation scheme used for the symbol sets is related to importance of the symbol sets; descramble, de-interleave, or split the M demodulation objects to obtain N bit streams; and decode the N bit streams separately by using one of the at least one decoding algorithm to obtain N pieces of enhancement sublayer information. The decoding algorithm used for the bit streams is related to importance of the bit streams. The enhancement layer information includes the N pieces of enhancement sublayer information. The N pieces of enhancement sublayer information are classified into levels based on importance. The importance indicates a degree of impact of the corresponding enhancement sublayer information on the image.

In embodiments, the processing module 1502 is configured to decode the base layer information to obtain a restored image; perform information combination, dequantization, inverse transform, and block combination processing on the enhancement layer information to obtain residual information; and obtain the image based on the restored image and the residual information.

The decoding apparatus for the receive end (e.g., the receiving end) provided in embodiments of this application is the destination device in the foregoing method, and has any function of the receive end in the foregoing method. For details, refer to the foregoing method. Details are not described herein again.

The foregoing describes the encoding apparatus for the transmit end and the decoding apparatus for the receive end in embodiments of this application. The following describes possible product forms of the encoding apparatus for the transmit end and the decoding apparatus for the receive end. It should be understood that any form of product having the features of the encoding apparatus for the transmit end in FIG. 14 and any form of product having the features of the decoding apparatus for the receive end in FIG. 15 fall within the protection scope of this application. It should be further understood that the following description is merely an example, and a product form of the encoding apparatus for the transmit end and a product form of the decoding apparatus for the receive end in embodiments of this application are not limited thereto.

As a possible product form, the encoding apparatus for the transmit end and the decoding apparatus for the receive end in embodiments of this application may be implemented by using general bus architectures.

The encoding apparatus for the transmit end includes a processor and a transceiver communicating with the processor. The processor is configured to: perform compression encoding on an image to obtain base layer information; obtain enhancement layer information based on the base layer information and the image; obtain control layer information, where the control layer information includes higher-layer control information, and control information of the base layer information and the enhancement layer information; perform channel encoding and modulation on the control layer information, the base layer information, and the enhancement layer information separately to obtain a plurality of symbol sets; and map the plurality of symbol sets to a resource to generate a first frame. The transceiver is configured to send the first frame. Optionally, the encoding apparatus for the transmit end may further include a memory. The memory is configured to store instructions executed by the processor.

The decoding apparatus for the receive end includes a processor and a transceiver communicating with the processor. The transceiver is configured to receive a first frame. The processor is configured to: demap the first frame to obtain a first symbol set corresponding to control layer information, a second symbol set corresponding to base layer information, and a third symbol set corresponding to enhancement layer information; perform demodulation and channel decoding on the first symbol set to obtain the control layer information, where the control layer information includes higher-layer control information, and control information of the base layer information and the enhancement layer information; perform demodulation and channel decoding on the second symbol set and the third symbol set separately based on the control layer information to obtain the base layer information and the enhancement layer information; and obtain an image based on the base layer information and the enhancement layer information. Optionally, the decoding apparatus for the receive end may further include a memory. The memory is configured to store instructions executed by the processor.

As a possible product form, the encoding apparatus for the transmit end and the decoding apparatus for the receive end in embodiments of this application may be implemented by using general-purpose processors.

The general-purpose processor for implementing the encoding apparatus for the receive end includes a processing circuit and an output interface communicating with the processing circuit. The processing circuit is configured to: perform compression encoding on an image to obtain base layer information; obtain enhancement layer information based on the base layer information and the image; obtain control layer information, where the control layer information includes higher-layer control information, and control information of the base layer information and the enhancement layer information; perform channel encoding and modulation on the control layer information, the base layer information, and the enhancement layer information separately to obtain a plurality of symbol sets; and map the plurality of symbol sets to a resource to generate a first frame. The output interface is configured to send the first frame. Optionally, the general-purpose processor may further include a storage medium. The storage medium is configured to store instructions executed by the processing circuit.

The general-purpose processor for implementing the decoding apparatus for the receive end includes a processing circuit and an input interface communicating with the processing circuit. The input interface is configured to receive a first frame. The processing circuit is configured to: demap the first frame to obtain a first symbol set corresponding to control layer information, a second symbol set corresponding to base layer information, and a third symbol set corresponding to enhancement layer information; perform demodulation and channel decoding on the first symbol set to obtain the control layer information, where the control layer information includes higher-layer control information, and control information of the base layer information and the enhancement layer information; perform demodulation and channel decoding on the second symbol set and the third symbol set separately based on the control layer information to obtain the base layer information and the enhancement layer information; and obtain an image based on the base layer information and the enhancement layer information. Optionally, the general-purpose processor may further include a storage medium. The storage medium is configured to store instructions executed by the processing circuit.

As a possible product form, the encoding apparatus for the transmit end and the decoding apparatus for the receive end in embodiments of this application may alternatively be implemented by using the following components: one or more FPGAs, programmable logic devices (PLDs), controllers, state machines, gate logic, discrete hardware components, any other suitable circuits, or any combination of circuits that can perform various functions described in this application.

It should be understood that the encoding apparatus for the transmit end and the decoding apparatus for the receive end in the foregoing product forms respectively have any function of the transmit end and any function of the receive end in the foregoing method embodiments. Details are not described herein again.

It should be understood that the term “and/or” in this specification describes only an association relationship between associated objects and represents that three relationships may exist. For example, A and/or B may represent the following three cases: Only A exists, both A and B exist, and only B exists. In addition, the character “I” in this specification generally indicates an “or” relationship between the associated objects.

A person of ordinary skill in the art may be aware that, in combination with the examples described in embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the embodiment goes beyond the scope of this application.

It may be clearly understood by a person skilled in the art that, for the purpose of convenient and brief description, for a detailed working process of the foregoing described system, apparatus, and unit, refer to a corresponding process in the foregoing method embodiment, and details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one location, or may be distributed on a plurality of network units. Some or all of the units may be selected according to actual requirements to achieve the objectives of the solutions of embodiments in this application.

In addition, function units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions in this application essentially, or the part contributing to the conventional technology, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods in the embodiments of this application. The storage medium includes any medium that can store program code, such as a USB flash drive, a removable hard disk, a ROM, a RAM, a magnetic disk, or an optical disc.

The foregoing descriptions are merely embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. An image encoding method, comprising:
performing compression encoding on an image to obtain base layer information;
obtaining enhancement layer information based on the base layer information and the image;
obtaining control layer information, wherein the control layer information comprises higher-layer control information, and control information of the base layer information and the enhancement layer information;
separately performing channel encoding and modulation on the control layer information, the base layer information, and the enhancement layer information separately to obtain a plurality of symbol sets; and
mapping the plurality of symbol sets to a resource for transmission.

2. The method according to claim 1, wherein the obtaining enhancement layer information based on the base layer information and the image comprises:
decoding the base layer information to obtain a restored image;
calculating a residual of the image and the restored image to obtain residual information; and
performing partition, transform, and quantization processing on the residual information to obtain the enhancement layer information.

3. The method according to claim 1, wherein the separately performing channel encoding and modulation on the control layer information, the base layer information, and the enhancement layer information to obtain the plurality of symbol sets comprises:
performing, on the control layer information, channel encoding by using a first encoding algorithm and performing modulation by using a first modulation scheme to obtain a first symbol set;
performing, on the base layer information, channel encoding by using a second encoding algorithm and performing modulation by using a second modulation scheme to obtain a second symbol set; and
performing, on the enhancement layer information, channel encoding by using at least one encoding algorithm and performing modulation by using at least one modulation scheme to obtain a third symbol set, wherein the at least one encoding algorithm does not comprise the first encoding algorithm or the second encoding algorithm, and the at least one modulation scheme does not comprise the first modulation scheme or the second modulation scheme.

4. The method according to claim 3, wherein the enhancement layer information comprises N pieces of enhancement sublayer information, the N pieces of enhancement sublayer information are classified into levels based on an importance, that indicates a degree of impact of the corresponding enhancement sublayer information on the image; and
the performing, on the enhancement layer information, channel encoding by using at least one encoding algorithm and performing modulation by using at least one modulation scheme to obtain the third symbol set comprises:
separately performing channel encoding on the N pieces of enhancement sublayer information by using one of the at least one encoding algorithm to obtain N bit streams, wherein the encoding algorithm used for the enhancement sublayer information is related to an importance of the enhancement sublayer information;
splicing, interleaving, or scrambling the N bit streams to obtain M modulation objects;
separately modulating the M modulation objects by using one of the at least one modulation scheme to obtain M symbol sets, wherein the modulation scheme used for the modulation objects is related to an importance of the M modulation objects; and
splicing the M symbol sets to obtain the third symbol set.

5. The method according to claim 1, wherein the mapping the plurality of symbol sets to a resource for transmission comprises:
sending the plurality of symbol sets by using a first frame, wherein the first frame comprises: a pilot, a frame header, the control information of the base layer information, the base layer information, the control information of the enhancement layer information, and the enhancement layer information; and the enhancement layer information comprises N pieces of enhancement sublayer information, and the control information of the enhancement layer information comprises N pieces of control sublayer information corresponding to the N pieces of enhancement sublayer information, respectively.

6. An image decoding method, comprising:
receiving a signal carried on a resource, and demapping the signal to obtain a first symbol set corresponding to control layer information, a second symbol set corresponding to base layer information, and a third symbol set corresponding to enhancement layer information;
performing demodulation and channel decoding on the first symbol set to obtain the control layer information, wherein the control layer information comprises higher-layer control information, and control information of the base layer information and the enhancement layer information;
separately performing demodulation and channel decoding on the second symbol set and the third symbol set based on the control layer information to obtain the base layer information and the enhancement layer information; and
obtaining an image based on the base layer information and the enhancement layer information.

7. The method according to claim 6, wherein the performing demodulation and channel decoding on the first symbol set to obtain the control layer information comprises:
performing, on the first symbol set, demodulation by using a first demodulation scheme and performing channel decoding by using a first decoding algorithm to obtain the control layer information.

8. The method according to claim 7, wherein the separately performing demodulation and channel decoding on the second symbol set and the third symbol set based on the control layer information to obtain the base layer information and the enhancement layer information comprises:
performing, on the second symbol set based on the control layer information, demodulation by using a second demodulation scheme and performing channel decoding by using a second decoding algorithm to obtain the base layer information; and
performing, on the third symbol set based on the control layer information, demodulation by using at least one demodulation scheme and performing channel decoding by using at least one decoding algorithm to obtain the enhancement layer information, wherein the at least one demodulation scheme does not comprise the first demodulation scheme or the second demodulation scheme, and the at least one decoding algorithm does not comprise the first decoding algorithm or the second decoding algorithm.

9. The method according to claim 8, wherein the performing, on the third symbol set based on the control layer information, demodulation by using at least one demodulation scheme and performing channel decoding by using at least one decoding algorithm to obtain the enhancement layer information comprises:
splitting the third symbol set based on the control layer information to obtain M symbol sets;
separately demodulating the M symbol sets by using one of the at least one demodulation scheme to obtain M demodulation objects, wherein the demodulation scheme used for the symbol sets is related to an importance of the symbol sets that indicates a degree of impact of the symbol sets on the image;
descrambling, de-interleaving, or splitting the M demodulation objects to obtain N bit streams; and
separately decoding the N bit streams by using one of the at least one decoding algorithm to obtain N pieces of enhancement sublayer information, wherein the decoding algorithm used for the bit streams is related to an importance of the bit streams that indicates a degree of impact of the bit streams on the image, the enhancement layer information comprises the N pieces of enhancement sublayer information, the N pieces of enhancement sublayer information are classified into levels based on an importance that indicates a degree of impact of the corresponding enhancement sublayer information on the image.

10. The method according to claim 6, wherein the obtaining an image according to the base layer information and the enhancement layer information comprises:
decoding the base layer information to obtain a restored image;
performing information combination, dequantization, inverse transform, and block combination processing on the enhancement layer information to obtain residual information; and
obtaining the image based on the restored image and the residual information.

11. An encoding apparatus, comprising:
a processor, configured to:
perform compression encoding on an image to obtain base layer information;
obtain enhancement layer information based on the base layer information and the image; obtain control layer information, wherein the control layer information comprises higher-layer control information, and control information of the base layer information and the enhancement layer information; and
separately perform channel encoding and modulation on the control layer information, the base layer information, and the enhancement layer information to obtain a plurality of symbol sets; and
a transceiver, configured to map the plurality of symbol sets to a resource for transmission.

12. The apparatus according to claim 11, wherein the processor is configured to decode the base layer information to obtain a restored image, calculate a residual of the image and the restored image to obtain residual information, and perform partition, transform, and quantization processing on the residual information to obtain the enhancement layer information.

13. The apparatus according to claim 11, wherein the processor is configured to:
perform, on the control layer information, channel encoding by using a first encoding algorithm and perform modulation by using a first modulation scheme to obtain a first symbol set;
perform, on the base layer information, channel encoding by using a second encoding algorithm and perform modulation by using a second modulation scheme to obtain a second symbol set; and
perform, on the enhancement layer information, channel encoding by using at least one encoding algorithm and perform modulation by using at least one modulation scheme to obtain a third symbol set, wherein the at least one encoding algorithm does not comprise the first encoding algorithm or the second encoding algorithm, and the at least one modulation scheme does not comprise the first modulation scheme or the second modulation scheme.

14. The apparatus according to claim 13, wherein the enhancement layer information comprises N pieces of enhancement sublayer information, the N pieces of enhancement sublayer information are classified into levels based on an importance that indicates a degree of impact of the corresponding enhancement sublayer information on the image; and the processing module is configured to:
separately perform channel encoding on the N pieces of enhancement sublayer information by using one of the at least one encoding algorithm to obtain N bit streams, wherein the encoding algorithm used for the enhancement sublayer information is related to the importance of the enhancement sublayer information; splice, interleave, or scramble the N bit streams to obtain M modulation objects;
separately modulate the M modulation objects by using one of the at least one modulation scheme to obtain M symbol sets, wherein the modulation scheme used for the modulation objects is related to an importance of the modulation objects that indicates a degree of impact of the corresponding modulation object; and
splice the M symbol sets to obtain the third symbol set.

15. The apparatus according to claim 11, wherein the transceiver is configured to send the plurality of symbol sets by using a first frame, wherein the first frame comprises: a pilot, a frame header, the control information of the base layer information, the base layer information, the control information of the enhancement layer information, and the enhancement layer information; and the enhancement layer information comprises the N pieces of enhancement sublayer information, and the control information of the enhancement layer information comprises N pieces of control sublayer information corresponding to the N pieces of enhancement sublayer information respectively.
